(19) United States
(12) Patent Application Publication
(10) Pub. No.: US 2024/0037380 A1
(43) Pub. Date: Feb. 1, 2024

(54) RESISTIVE MEMORY CIRCUIT FOR LIQUID STATE MACHINE WITH TEMPORAL CLASSIFCATION

(71) Applicant: University of Dayton, Dayton, OH (US)

(72) Inventors: Alex Henderson, Beavercreek, OH (US); Chris Yakopcic, Dayton, OH (US); Tarek M. Taha, Centerville, OH (US)

(21) Appl. No.: 18/226,658

(22) Filed: Jul. 26, 2023

Related U.S. Application Data
(60) Provisional application No. 63/392,432, filed on Jul. 26, 2022.

(51) Int. Cl. G06N 3/065; G06N 3/049

(52) U.S. Cl. CPC G06N 3/065; G06N 3/049

(57) ABSTRACT

An analog neuromphric circuit is disclosed having an input layer, a liquid layer, and an output layer each with resistive memory crossbar configurations to identify a temporal signal for a duration of time. The input layer encodes input layer spiking neurons based on encoding signals generated from input voltages applied an input layer resistive memory crossbar configuration. The liquid layer counts each spike generated by liquid layer spiking neurons for the duration of time based on liquid layer signals generated from the input spiking neuron voltages generated from each input layer spiking neurons applied to a liquid layer resistive memory crossbar configuration. The output layer identifies the temporal signal for the duration of time based on output voltages generated from the counting voltages generated from each count of each spike generated by the liquid layer spiking neurons for the duration of time applied to an output resistive memory crossbar configuration.

### CROSS-REFERENCE TO RELATED APPLICATIONS

The present application is a U.S. Nonprovisional Application of U.S. Provisional Application Ser. No. 63/392,432 filed Jul. 26, 2022, the disclosure of which is incorporated by reference in its entirety.

### FIELD OF THE INVENTION

This invention relates to neural networks, and more particularly, to systems and methods for implementing resistive memories in an analog neuromorphic circuit.

### BACKGROUND OF THE INVENTION

Traditional computing systems use conventional microprocessor technology in that operations are performed in chronological order such that each operation is completed before the subsequent operation is initiated. The operations are not performed simultaneously. For example, an addition operation is completed before the subsequent multiplication operation is initiated. The chronological order of operation execution limits the performance of conventional microprocessor technology. Conventional microprocessor design is limited in how small the microprocessors can be designed, the amount of power that the microprocessors consume, as well as the speed in which the microprocessors execute operations in chronological order. Thus, conventional microprocessor technology is proving insufficient in applications that require significant computational efficiency, such as in image recognition.

It is becoming common wisdom to use conventional neuromorphic computing networks which are laid out in a similar fashion as the human brain. Hubs of computing power are designed to function as a neuron in the human brain where different layers of neurons are coupled to other layers of neurons. This coupling of neurons enables the neuromorphic computing network to execute multiple operations simultaneously. Therefore, the neuromorphic computing network has exponentially more computational efficiency than traditional computing systems.

Conventional neuromorphic computing networks are implemented in large scale computer clusters which include computers that are physically large in order to attain the computational efficiency necessary to execute applications such as image recognition. For example, applications of these large scale computer clusters include rows and rows of physically large servers that may attain the computational efficiency necessary to execute image recognition when coupled together to form a conventional neuromorphic computing network. Such large scale computer clusters not only take up a significant amount of physical space but also require significant amounts of power to operate.

The significant amount of physical space and power required to operate conventional neuromorphic computing networks severely limits the types of applications for which conventional neuromorphic computing networks may be implemented. For example, industries such as biomedical, military, robotics, and mobile devices are industries that cannot implement conventional neuromorphic computing networks due to the significant space limitations in such industries as well as the power limitations. Therefore, an effective means to decrease the space and the power required by conventional neuromorphic computing is needed.

### SUMMARY OF THE INVENTION

The present invention provides an analog neuromorphic circuit that implements a plurality of resistive memories. The analog neuromorphic circuit includes an input layer that is configured to encode a plurality of input voltages applied to the input layer via an input layer resistive memory crossbar configuration thereby encoding each input layer spiking neuron to spike when the corresponding encoding signal applied to each input layer spiking neuron is increased above an input layer spiking voltage threshold. The encoding signal applied to each input layer spiking neuron that is increased above the input spiking threshold is indicative of a temporal signal for a duration of time. A liquid layer is configured to count each spike generated by a plurality of liquid layer spiking neurons for the duration of time based on a plurality of liquid layer signals generated from a plurality of input layer spiking neuron voltages generated from each input layer spiking neuron based on the plurality of input layer spiking neuron voltages applied to the liquid layer via a liquid layer resistive memory crossbar configuration thereby triggering each liquid layer spiking neuron to spike when the corresponding liquid layer signal is increased above a liquid layer spiking threshold. Each spike generated by the plurality of liquid layer spiking neurons for the duration of time that is generated is indicative of the temporal signal for the duration of time. An output layer is configured to identify the temporal signal for the duration of time based on a plurality of output voltages generated from a plurality of counting voltages generated from the count of each spike generated by the plurality of liquid layer spiking neurons for the duration of time applied to the output layer via an output resistive memory crossbar configuration. The plurality of output voltages generated form the output resistive memory crossbar configuration is indicative of the temporal signal for the duration of time.

The present invention also provides a method for implementing an analog neuromorphic circuit to identify a temporal signal for a duration of time. The method starts with encoding a plurality of input layer spiking neurons based on a plurality of encoding signals generated from a plurality of input voltages applied to the input layer via an input layer resistive memory crossbar configuration thereby encoding each input layer spiking neuron to spike when the corresponding encoding signal applied to each input layer spiking neuron is increased above an input layer spiking voltage threshold. The encoding signal applied to each input layer spiking neuron that is increased above the input spiking threshold is indicative of a temporal signal for a duration of time. Each spike generated by a plurality of liquid layer spiking neurons is counted for the duration of time based on a plurality of liquid layer signals generated from a plurality of input layer spiking neuron voltages generated from each input layer spiking neuron based on the plurality of input layer spiking neuron voltages applied to the liquid layer via a liquid layer resistive memory crossbar configuration thereby triggering each liquid layer spiking neuron to spike when the corresponding liquid layer signal is increased above a liquid layer spiking voltage threshold. Each spike generated by the plurality of liquid layer spiking neurons for the duration of time that is generated is indicative of the temporal signal for the duration of time. The temporal signal is identified for the duration of time based on a plurality of output voltages generated from a plurality of counting voltages generated from the count of each spike generated by the plurality of liquid layer spiking neurons for the duration of time applied to the output layer via an output resistive memory crossbar configuration. The plurality of output voltages generated from the output resistive memory crossbar configuration is indicative of the temporal signal for the duration of time.

The present invention also provides an analog neuromorphic circuit that implements a plurality of resistive memories. The analog neuromorphic circuit includes an input layer configured to encode a plurality of input layer spiking neurons based on a plurality of encoding signals generated from a plurality of input voltages applied to the input layer via an input layer resistive memory crossbar configuration thereby encoding each input layer spiking neuron to spike when the corresponding encoding signal is applied to each input layer spiking neuron is increased above an input layer spiking voltage threshold. The encoding signal is applied to each input layer spiking neuron that is increased above the input spiking neuron threshold is indicative of a temporal signal for a duration of time. A liquid layer is configured to count each spike generated by a plurality of liquid layer spiking neurons for the duration of time based on a plurality of liquid layer signals generated from a plurality of input layer spiking neuron voltages generated from each input layer spiking neuron based on the plurality of input layer spiking neuron voltages applied to the liquid layer via a liquid layer resistive memory crossbar configuration thereby triggering each liquid layer spiking neuron to spike when the corresponding liquid layer signal is increased above a liquid layer spiking voltage threshold. Each spike generated by the plurality of liquid layer spiking neurons for the duration of time that is generated is indicative of the temporal signal for the duration of time. An output layer is configured to generate an identified temporal signal converted from a plurality of output voltages generated from a plurality of counting voltages generated from the count of each spike generated by the plurality of liquid layer spiking neurons for the duration of time applied to the output layer via an output resistive memory crossbar configuration. The identified temporal signal converted from the plurality of output voltages generated from the output resistive memory crossbar configuration is an attempt to identify the temporal signal for the duration of time. A training layer is configured to train the output resistive memory crossbar configuration based on a difference in the identified temporal signal converted from the output voltages of the output resistive memory crossbar configuration as compared to the temporal signal for the duration of time. The output resistive memory crossbar configuration is trained to reduce the difference between the identified temporal signal and the temporal signal for the duration of time.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention. Additionally, the left most digit(s) of a reference number identifies the drawing in which the reference number first appears.

FIG. 1 is a schematic illustration of an exemplary analog neuromorphic processing device that simultaneously executes several computing operations in parallel in accordance with an embodiment of the disclosure;

FIG. 2 is a schematic illustration of an exemplary analog neuromorphic circuit that simultaneously executes several computing operations in parallel in accordance with an embodiment of the disclosure;

FIG. 3 is a schematic illustration of an exemplary neural network configuration that the analog neuromorphic circuit of FIG. 2 may be implemented and scaled in accordance with an embodiment of the disclosure;

FIG. 4 is a schematic illustration of a detailed analog neuromorphic liquid state configuration in accordance with an embodiment of the disclosure;

FIG. 5 is a schematic illustration of a detailed a detailed input layer configuration in accordance with an embodiment of the disclosure;

FIG. 6 is a schematic illustration of a voltage to current converter in accordance with an embodiment of the disclosure;

FIG. 7 is a schematic illustration of a neuron circuit configuration in accordance with an embodiment of the disclosure;

FIG. 8 is a schematic illustration of a detailed a detailed liquid layer configuration in accordance with an embodiment of the disclosure;

FIG. 9 is a schematic illustration of a spike counter circuit configuration in accordance with an embodiment of the disclosure;

FIG. 10 is a schematic illustration of a detailed output layer configuration in accordance with an embodiment of the disclosure;

FIG. 11 is a schematic illustration of a comparator circuit configuration in accordance with an embodiment of the disclosure; and

FIG. 12 is a schematic illustration of a training liquid state configuration in accordance with an embodiment of the disclosure.

### DETAILED DESCRIPTION

The following Detailed Description refers to accompanying drawings to illustrate exemplary embodiments consistent with the present disclosure. References in the Detailed Description to “one embodiment,” “an embodiment,” “an exemplary embodiment,” etc., indicate that the exemplary embodiment described can include a particular feature, structure, or characteristic, but every exemplary embodiment does not necessarily include the particular feature, structure, or characteristic. Moreover, such phrases are not necessarily referring to the same embodiment. Further, when a particular feature, structure, or characteristic is described in connection with an embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other embodiments are possible, and modifications can be made to exemplary embodiments within the scope of the present disclosure. Therefore, the Detailed Description is not meant to limit the present disclosure. Rather, the scope of the present disclosure is defined only in accordance with the following claims and their equivalents.

Embodiments of the present invention may be implemented in hardware, firmware, software, or any combination thereof. Embodiments of the present invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, and/or instructions may be described herein as performing certain actions. However, it should be appreciated that such descriptions are merely for convenience and that such actions in fact result from computing devices, processors, controllers, or other devices executing the firmware, software, routines, instructions, etc.

For purposes of this discussion, each of the various components discussed may be considered a module, and the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the present disclosure that others can, by applying knowledge of those skilled in the relevant art(s), readily modify and/or adapt for various applications such exemplary embodiments, without undue experimentation, without departing from the scope of the present disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not limitation, such that the terminology or phraseology of the present specification is to be interpreted by those skilled in relevant art(s) in light of the teachings herein.

The present invention creates an analog neuromorphic computing network by implementing resistive memories. A resistive memory is a non-volatile, variable resistor that may not only change the resistance level but may also maintain the resistance level after power to the resistive memory has been terminated so that the resistive memory acts as memory. A combination of resistive memories may generate output values that may be positive and/or negative. Such characteristics of the resistive memory enables neuromorphic computing to be shrunk down from implementing large computers to a circuit that can be fabricated onto a chip while requiring minimal power due to the analog characteristics of the resistive memory.

The resistive memories may be positioned in a crossbar configuration in that each resistive memory is positioned at an intersection of a plurality of horizontal wires and a plurality of vertical wires forming a wire grid. An input voltage may be applied to each horizontal wire. Each resistive memory may apply a resistance to each input voltage so that each input voltage is multiplied by each resistance. The positioning of each resistive memory at each intersection of the wire grid enables the multiplying of each input voltage by the resistance of each resistive memory to be done in parallel. The multiplication in parallel enables multiple multiplication operations to be executed simultaneously. Each current relative to each horizontal wire may then be added to generate an accumulative current that is conducted by each vertical wire. The addition of each current to generate the accumulative currents is also done in parallel due to the positioning of the resistive memories at each intersection of the wire grid. The addition in parallel also enables multiple addition operations to be executed simultaneously. The simultaneous execution of addition and multiplication operations in an analog circuit generates significantly more computational efficiency than conventional microprocessors while implementing significantly less power than conventional microprocessors.

The terms “horizontal” and “vertical” are used herein for ease of discussion to refer to one example of the invention. It should be understood however that such orientation is not required, nor is a perpendicular intersection required. It is sufficient that a plurality of parallel wires intersects a pair of parallel wires to form a crossbar or grid pattern having two wires for adding current and two or more wires for inputting voltages, with a resistive memory positioned at each intersection for multiplication. The intersections may occur at right angles (orthogonal crossing lines) or non-right angles. It may be understood, however, that the orthogonal arrangement provides the simplest means for scaling the circuit to include additional neurons and/or layers of neurons. Further, it may be understood than an orientation having horizontal rows and/or vertical columns is also simpler for scaling purposes and is a matter of the point of reference, and should not be considered limiting. Thus, any grid configuration orientation is contemplated.

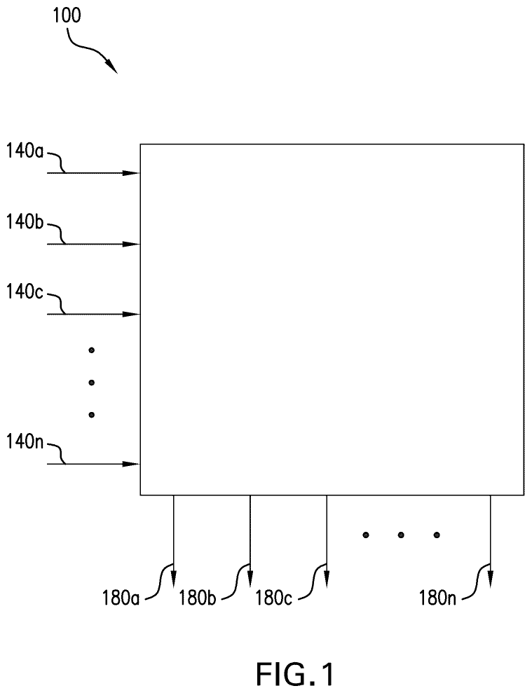

Referring to FIG. 1, an analog neuromorphic processing device 100 simultaneously executes several computing operations in parallel. The analog neuromorphic processing device 100 includes a plurality of input voltages 140(a-n) that are applied to a plurality of respective inputs of the analog neuromorphic processing device 100 and the analog neuromorphic processing device 100 then generates a plurality of output signals 1 80(a-n).

The analog neuromorphic processing device 100 may include a plurality of resistive memories (not shown) that have variable resistance characteristics that may be exercised not only with low levels of power but may also exercise those variable resistance characteristics after power applied to the resistive memories has been terminated. The variable resistance characteristics of the resistive memories enable the resistive memories to act as memory while maintaining significantly low power requirements compared to conventional microprocessors. The resistive memories are also of nano-scale sizes that enable a significant amount of resistive memories to be configured within the analog neuromorphic processing device 100 while still maintaining significantly low power level requirements. The variable resistance capabilities of the resistive memories coupled with the nano-scale size of the resistive memories enable the resistive memories to be configured so that the analog neuromorphic processing device 100 has significant computational efficiency while maintaining the size of the analog neuromorphic processing device 100 to a chip that may easily be positioned on a circuit board.

For example, the resistive memories may include but are not limited to memristors that are nano-scale variable resistance devices with a significantly large variable resistance range. The physics of the resistive memories, such as memristors, require significantly low power and occupy little space so that the resistive memories may be configured in the analog neuromorphic processing device 100 to generate significant computational efficiency from a small chip.

The plurality of input voltages 140(a-n), where n is an integer greater than or equal to one, may be applied to corresponding inputs of the analog neuromorphic processing device 100 to exercise the variable resistance characteristics of the resistive memories. The input voltages 140(a-n) may be applied at a voltage level and for a time period that is sufficient to exercise the variable resistance characteristics of the resistive memories. The input voltages 140(a-n) may vary and/or be substantially similar depending on the types of variable resistance characteristics that are to be exercised by each of the resistive memories.

The resistive memories may be arranged in the analog neuromorphic processing device 100 such that the resistive memories may simultaneously execute multiple addition and multiplication operations in parallel in response to the input voltages 140(a-n) being applied to the inputs of the analog neuromorphic processing device 100. The variable resistance characteristics of the resistive memories as well as their nano-scale size enables a significant amount resistive memories to be arranged so that the input voltages 140(a-n) trigger responses in the resistive memories that are then propagated throughout the analog neuromorphic processing device 100 that results in simultaneous multiplication and addition operations that are executed in parallel.

The simultaneous multiplication and addition operations executed in parallel exponentially increases the efficiency of analog neuromorphic processing device 100 while limiting the power required to obtain such computation capabilities to the input voltages 140(a-n). The resistive memories are passive devices so that the simultaneous multiplication and addition operations executed in parallel are performed in the analog domain, which also exponentially decreases the required power. For example, the analog neuromorphic processing device 100 may have significantly more computational efficiency than traditional microprocessor devices, and may be smaller than traditional microprocessor chips while reducing power in a range from 1,000 times to 1,000,000 times that of traditional microprocessors.

The resistive memories may also be arranged such that the simultaneous execution of the multiplication and addition operations in parallel may be configured as a single computation hub that constitutes a single neuron in a neural network. The variable resistance characteristics and the nano-scale size of the resistive memories further enable the arrangement of resistive memories to be scaled with other arrangements of resistive memories so that the single neuron may be scaled into a neural network including multiple neurons. The scaling of a single neuron into multiple neurons exponentially further increases the computational efficiency of the resulting neural network. In addition, the multiple neurons may be scaled into several layers of neurons that further exponentially increases the computational efficiency of the neural network. The scaling of the resistive memories into additional neurons may be done within the analog neuromorphic processing device 100 such as within a single chip. However, the analog neuromorphic processing device 100 may also be scaled with other analog neuromorphic circuits contained in other chips to exponentially increase the computational efficiency of the resulting neural network.

As a result, the analog neuromorphic processing device 100 may be configured into a neural network that has the capability of executing applications with significant computational efficiency, such as image recognition. For example, the output signals 180(a-n), where n is an integer greater than or equal to one, may generate signals that correctly identify an image. The analog neuromorphic processing device 100 may also have the learning capability as will be discussed in further detail below so that analog neuromorphic circuits may successfully execute learning algorithms.

The analog neuromorphic processing device 100 implemented as a single neuron and/or multiple neurons in a neural network and/or configured with other similar analog neuromorphic processing device 100 may have significant advantages in traditional computing platforms that require significant computational efficiency with limited power resources and space resources. For example, such traditional computing platforms may include but are not limited to Fast Fourier Transform (FFT) applications, Joint Photographic Experts Group (JPEG) image applications, and/or root mean square (RMS) applications. The implementation of low power neural networks that have a limited physical footprint may also enable this type of computational efficiency to be utilized in many systems that have traditionally not been able to experience such computational efficiency due to the high power consumption and large physical footprint of conventional computing systems. Such systems may include but are not limited to military and civilian applications in security (image recognition), robotics (navigation and environment recognition), and/or medical applications (artificial limbs and portable electronics).

The layering of the analog neuromorphic processing device 100 with other similar analog neuromorphic circuits may enable complex computations to be executed. The compactness of the resistive memory crossbar configurations enables fabrication of chips with a high synaptic density in that each chip may have an increased amount of neurons that are fitted onto the chip. The passive characteristics of the resistive memories eliminate the need for software code which increases the security of the analog neuromorphic processing device 100.

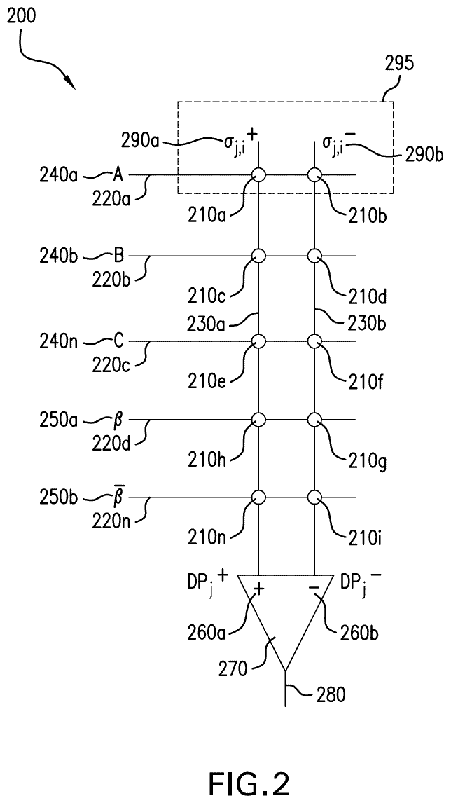

Referring to FIG. 2, an analog neuromorphic circuit 200 simultaneously executes several computing operations in parallel. The analog neuromorphic circuit 200 includes a plurality of resistive memories 210(a-n) where n is an integer equal to or greater than four, a plurality of horizontal wires 220(a-n) where n is an integer equal to or greater than two, a pair of vertical wires 230(a-b), a plurality of input voltages 240(a-n) where n is an integer equal to or greater than two, a pair of bias voltage connections 250(a-b), a first and second input of a comparator 260(a-b), a comparator 270, an output of the comparator 280, a pair of weights 290(a-b), and a combined weight 295. The analog neuromorphic circuit 200 shares many similar features with the analog neuromorphic processing device 100; therefore, only the differences between the analog neuromorphic circuit 200 and the analog neuromorphic processing device 100 are to be discussed in further detail.

The analog neuromorphic circuit 200 may be representative of a single neuron of a neural network. The analog neuromorphic circuit 200 has the capability to be scaled to interact with several other analog neuromorphic circuits so that multiple neurons may be implemented in the neural network as well as creating multiple layers of neurons in the neural network. Such a scaling capability to include not only multiple neurons but also multiple layers of neurons significantly magnifies the computational efficiency of the neural network, as will be discussed in further detail below.

The resistive memories 210(a-n) may be laid out in a crossbar configuration that includes a high density wire grid. The crossbar configuration enables the resistive memories 210(a-n) to be tightly packed together in the wire grid as will be discussed in further detail below. The tightly packed resistive memories 210(a-n) provides a high density of resistive memories 210(a-n) in a small surface area of a chip such that numerous analog neuromorphic circuits may be positioned in a neural network on a chip while occupying little space. The crossbar configuration also enables the resistive memories 210(a-n) to be positioned so that the analog neuromorphic circuit 200 may execute multiple addition and multiplication operations in parallel in the analog domain. The numerous neuromorphic circuits may then be positioned in the neural network so that the multiple addition and multiplication operations that are executed in parallel may be scaled significantly, thus exponentially increasing the computational efficiency. The resistive memories 210(a-n) are passive devices so that the multiple addition and multiplication operations executed in parallel are done in the analog domain, which also exponentially decreases the required power.

In an embodiment, the horizontal wires 220(a-n) may be positioned to intersect with the vertical wires 230(a-b) to form a wire grid. In an embodiment, the horizontal wires 220(a-n) may be positioned orthogonal to the vertical wires 230(a-b). Each of the resistive memories 210(a-n) may be positioned at an intersection of the wire grid. For example resistive memory 210a is positioned at the intersection of horizontal wire 220a and the vertical wire 230a; the resistive memory 210b is positioned at the intersection of horizontal wire 220b and the vertical wire 230b and so on. The positioning of the horizontal wires 220(a-n) and the vertical wires 230(a-b) to form a wire grid and the positioning of each of the resistive memories 210(a-n) at each intersection of the wire grid may form the crossbar configuration.

Input voltages 240(a-n) may be applied to each of the respective horizontal wires 220(a-c). In FIG. 1, the input voltage 240a is represented by “A”, the input voltage 240b is represented by “B”, and the input voltage 240n is represented by “C”. For example, the input voltage 240a may be applied to the horizontal wire 220a, the input voltage 240b may be applied to the horizontal wire 220b, and the input voltage 240c may be applied to the horizontal wire 220c. As each of the input voltages 240(a-n) is applied to each of the respective horizontal wires 220(a-c), the resistance of each of the respective resistive memories 210(a-f) is multiplied with each of the respective input voltages 240(a-n) to generate a current that is then conducted by each of the respective vertical wires 230(a-b). The crossbar configuration then enables the multiplication of each of the respective input voltages 240(a-n) with the resistance of each of the resistive memories 210(a-f) in parallel so that each of the multiplications is executed simultaneously. The execution of multiple multiplication operations in parallel results in significant computational efficiency as compared to traditional microprocessors that execute each multiplication operation in a chronological order in that the current multiplication operation is completed before the subsequent multiplication operation is executed.

For example, the input voltage 240a is applied to the horizontal wire 220a. The resistance of the resistive memory 210a is multiplied with the input voltage 240a to generate a current that is then conducted by the vertical wire 130a that intersects the horizontal wire 220a at the resistive memory 210a. The resistance of the resistive memory 210b is multiplied with the input voltage 240a to generate a current that is then conducted by the vertical wire 230b that intersects the horizontal wire 220a at the resistive memory 210b. The crossbar configuration then enables the input voltage 240a to not only be multiplied by the resistance of the resistive memory 210a to generate the current conducted by the vertical wire 230a but also the multiplication of the input voltage 140a by the resistance of the resistive memory 210b in parallel to generate current conducted by the vertical wire 230b. The multiplication of the input voltages 240b to 240n happens in a similar fashion simultaneously with the multiplication of the input voltage 240a.

As each of the currents relative to each of the horizontal wires 220(a-c) are conducted by each of the vertical wires 230(a-b), those currents are then added to generate accumulative currents that are conducted by each of the respective vertical wires 230(a-b). For example and as noted above, the application of the input voltage 240a to the horizontal wire 220a is multiplied by the resistance of the resistive memory 210a to generate a current that is then conducted by the vertical wire 230a. The application of the input voltage 240b to the horizontal wire 220b is multiplied by the resistance of the resistive memory 210c to generate a current that is also conducted by the vertical wire 230a. The current generated from the input voltage 240a being applied to the horizontal wire 220a is then added to the current generated from the input voltage 240b being applied to the horizontal wire 220b. The addition of the current generated from the input voltage 240n being applied to the horizontal wire 220c that is multiplied by the resistance of the resistive memory 210e is also added to the currents generated by the input voltage 240a being applied to the horizontal wire 220a and the input voltage 240b being applied to the horizontal wire 220b to generate an accumulative current.

The adding of currents conducted by the vertical wire 230b is also done in a similar manner. The crossbar configuration enables the adding of the currents conducted by the vertical wire 230a to be done in parallel with the adding of the currents conducted by the vertical wire 230b so that the addition operations are done simultaneously. The crossbar configuration also enables the adding of the currents to be done simultaneously with the multiplication of each of the input voltages 240(a-n) with the resistance of each of the respective resistive memories 210(a-f). The simultaneous execution of multiple addition operations as well as multiple multiplication operations results in significant computational efficiency as compared to traditional microprocessors that execute each multiplication operation and then each addition operation in a chronological order in that the current multiplication operation is completed before the subsequent addition operation is executed.

As a result, the analog neuromorphic circuits that are configured into a neural network have the capability of executing applications requiring significant computation power, such as image recognition. Resistive memories 210(a-f) may be utilized in analog neuromorphic systems to approximate the concept of synaptic connectivity in which the resistive memories 210(a-f) may be used to store the connection strength between a neuron and all incoming connections as discussed in detail in U.S. Nonprovisional application Ser. No. 17/362,272 which is incorporated by reference in its entirety. The analog neuromorphic circuits also have learning capability as will be discussed in further detail below so that the analog neuromorphic circuits may successfully execute learning algorithms.

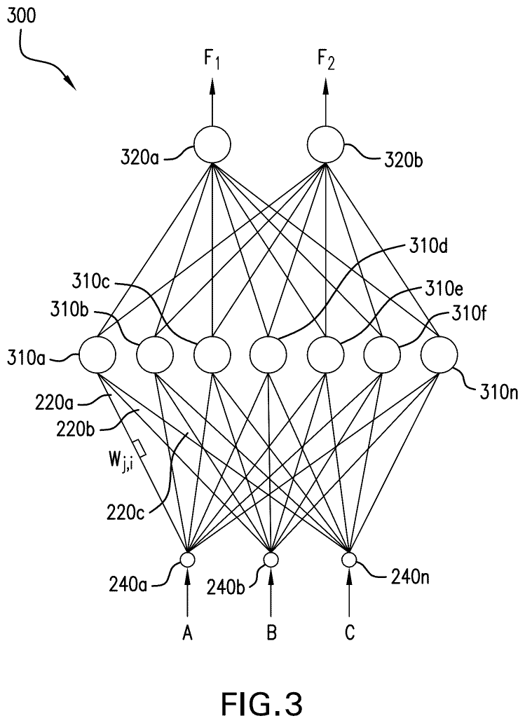

Referring to FIG. 3, in which like reference numerals are used to refer to like parts, neural network configuration 300 that the analog neuromorphic circuit 200 may be implemented and scaled into is shown. The neural network configuration 300 shares many similar features with the analog neuromorphic processing device 100 and the analog neuromorphic circuit 200; therefore, only the differences between the neural network configuration 200 and the analog neuromorphic processing device 100 and the analog neuromorphic circuit 200 are to be discussed in further detail.

The analog neuromorphic circuit 200 may be implemented into the neural network configuration 300. The analog neuromorphic circuit 200 may constitute a single neuron, such as neuron 310a in the neural network configuration 300. As shown in FIG. 3, the input voltage 240a and represented by “A” is applied to the horizontal wire 220a, the input voltage 240b and represented by “B” is applied to the horizontal wire 220b, and the input voltage 240n and represented by “C” is applied to the horizontal wire 220c. The combined weight 295 as shown in FIG. 2 as representative of the combined weight for the input voltage 240a is shown as W, j in FIG. 3. Similar combined weights for the input voltage 240b and the input voltage 240n may also be represented in FIG. 3 in a similar fashion. The wire grid, the resistive memories 210(a-n), and the comparator 270 are represented by the neuron 310a. The output 280 of the analog neuromorphic circuit 200 is coupled to additional neurons 320a and 320b.

The analog neuromorphic circuit 200 may then be scaled so that similar circuits may be configured with the analog neuromorphic circuit 200 to constitute additional neurons, such as neurons 310(b-n) where n is an integer greater than or equal to two. Each of the other neurons 310(b-n) includes similar circuit configurations as the analog neuromorphic circuit 200. However, the resistances of the resistive memories associated with each of the other neurons 310(b-n) may differ from the analog neuromorphic circuit 200 so that outputs that differ from the output 280 of the analog neuromorphic circuit 200 may be generated.

Rather than limiting the input voltages 240(a-n) to be applied to a single neuron 310, the input voltages 240(a-n) may also be applied to multiple other neurons 310(b-n) so that each of the additional neurons 310(b-n) also generate outputs that differ from the output 280 generated by the analog neuromorphic circuit 200. The generation of multiple different outputs from the different neurons 310(a-n) exponentially increases the computational efficiency of the neural network configuration 300. As noted above, the analog neuromorphic circuit 200 represented by the neuron 310a operates as a single logic function with the type of logic function being adjustable. The addition of neurons 310(b-n) provides additional logic functions that also have the capability of their logic functions being adjustable so that the computational efficiency of the neural network configuration 300 is significant.

In addition to having several different neurons 310(a-n), the analog neuromorphic circuit 200 may also be scaled to include additional layers of neurons, such as neurons 320(a-b). The scaling of additional layers of neurons also exponentially increases the computational efficiency of the neural network configuration 300 to the extent that the neural network configuration 300 can execute learning algorithms. For example, a neural network configuration with a significant number of input voltages, such as several hundred, that are applied to a significant number of neurons, such as several hundred, that have outputs that are then applied to a significant number of layers of neurons, such as ten to twenty, may be able to execute learning algorithms. The repetitive execution of the learning algorithms by the extensive neural network configuration may result in the neural network configuration eventually attaining automatic image recognition capabilities.

For example, the neural network configuration may eventually output a high voltage value of “F₁” representative of the binary signal “1” and output a low voltage value of “F₂” representative of the binary signal “0” when the neural network configuration recognizes an image of a dog. The neural network configuration may then output a low voltage value of “F₁” representative of the binary signal “0” and output a high voltage value of “F₂” representative of the binary signal “1” when the neural network configuration recognizes an image that is not a dog.

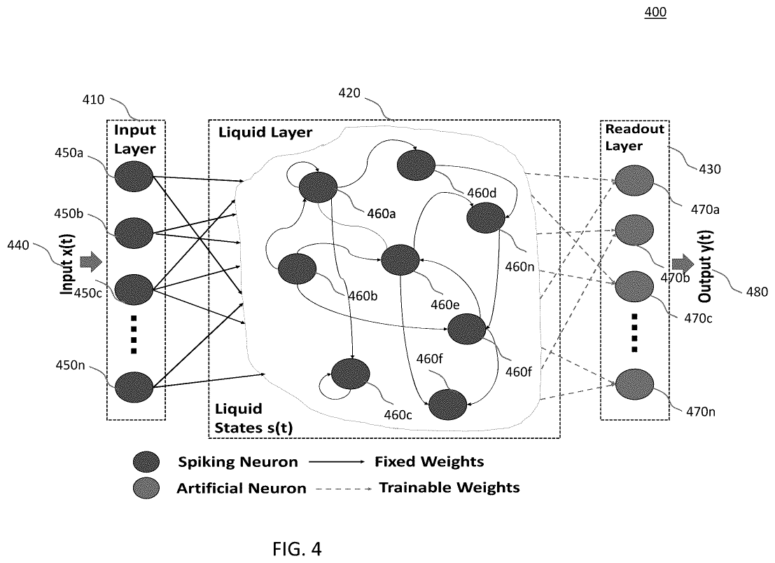

Referring to FIG. 4, in which like reference numerals are used to refer to like parts, a detailed analog neuromorphic liquid state configuration 400 is shown. The analog neuromorphic liquid state configuration 400 shares many similar features with the analog neuromorphic processing device 100, the analog neuromorphic circuit 200, and the neural network configuration 300; therefore, only the differences between the analog neuromorphic liquid state configuration 400 and the analog neuromorphic processing device 100, the analog neuromorphic circuit 200 and the neural network configuration 300 are to be discussed in more detail.

The analog neuromorphic liquid state configuration 400 includes an input layer 410, a liquid layer 420, and an output layer 430. An input signal 440 may be applied to the input layer 410. The input signal 440 is a temporal signal that spans a duration of time in which the input signal 440 includes a data pattern in a single data stream that is time varying. For example, the input signal 440 may include an audio signal that is sampled over a duration of time thereby generating a data pattern included in that audio signal that varies over the duration of time. The input signal 440 that includes a data pattern provided in a single data stream that is time varying differs from numerous static signals with each static signal including a data pattern that is captured from a static data set numerous times.

For example, a static image captured of a stationary object with 1000 pixels may have the input data bifurcated for each pixel such that numerous inputs associated with the input data of each pixel may be applied to a conventional deep neural network (CNN) and/or the simulated neural network (SNN). In doing so, the numerous inputs associated with the input data of each pixel may be included in static data signals that may be generated from capturing numerous images of the stationary object over and over again. In such an example, the static data sets provided by the pixels of each image captured from the stationary object is static and not time varying in which the static data sets do not change over time as the input signal 440 does with the data pattern in a single data stream that is a temporal signal that is time varying. Conventional deep neural networks such as the convolutional neural network (CNN) and the simulated neural network (SNN) without any additional layers fail to recognize a temporal signal that spans the duration of time with a data pattern that is time varying such as the input signal 440.

However, the analog neuromorphic liquid state configuration 400 may recognize a temporal signal that spans the duration of time in the time domain where conventional deep neural networks fail to do so. The input signal 440 that is the temporal signal that spans the duration of time in which the data pattern included in the input signal 440 varies over the duration of time. The input layer 410 may classify the input signal 440 in the time domain in which the data pattern of the input signal 440 is bifurcated into sections with regard to the time domain. For example, an audio signal may be classified based on frequency ranges of the audio signal. In such an example the data pattern may be bifurcated into a low frequency range, a medium frequency range, and a high frequency range. In doing so, a plurality of input layer spiking neurons 450(a-n), where n is an integer equal to or greater than one, included in the input layer 410 may be associated with each of the different data patterns classified from the input signal 440. For example, a first set of input layer spiking neurons 450(a-n) may be associated with the data pattern in the low frequency range such that the first set of input layer spiking neurons spike based on the data pattern in the low frequency range. A second set of input layer spiking neurons 450(a-n) may be associated with the data pattern in the in medium frequency range. A third set of input layer spiking neurons 450(a-n) may be associated with the data pattern in the high frequency range.

The classification of the data pattern in which the data pattern is bifurcated into data patterns for each classification that is included in the low frequency range thereby triggers the first set of input layer spiking neurons 450(a-n) to spike when the classified data pattern included in the data pattern as bifurcated into the low frequency range is identified. The classification of the data pattern in which the data pattern is bifurcated into data that is included in the medium frequency range thereby triggers the second set of input layer spiking neurons 450(a-n) to spike when the data included in the data pattern as bifurcated into the medium frequency range is identified. The classification of the data pattern in which the data pattern is bifurcated into data that is included in the high frequency range thereby triggers the third set of input layer spiking neurons 450(a-n) to spike when the data included in the data pattern as bifurcated into the high frequency range is identified.

In doing so, the input layer 440 may classify the data pattern included in the input signal 440 in a manner that bifurcates the data pattern into input data that may then be applied to the liquid layer 420 such that the liquid layer 420 may then identify when each data pattern bifurcated into the different classifications in the time domain by the input layer 410 are present. The liquid layer 420 may operate as a liquid state machine in which the input layer 410 provides the data pattern of the input signal 440 bifurcated into the different classifications in the time domain. The liquid layer 420 may then identify when the data included in the data pattern of each corresponding different classification in the time domain is present by counting the spikes during a duration of time generated by a plurality of liquid layer spiking neurons 460(a-n), where n is an integer equal to or greater than one, included in the liquid layer 420. As noted above, the input signal 440 is a temporal signal that is sampled over a duration of time. The liquid layer 420 may then count the spikes generated by the liquid layer spiking neurons 460(a-n) during the duration of time in which the temporal signal provided by the input signal 440 is sampled.

The spike counts generated by the liquid layer spiking neurons 460(a-n) during the duration of time may differentiate for different temporal signals as provided by the input signal 440. For example, a temporal signal of a classical sampling provided by the input signal 440 may generate a different count in spikes generated by the liquid layer spiking neurons 460(a-n) as compared to the count in spikes generated by a temporal signal of a ragtime sampling as provided by the input signal 440 and by a temporal signal of a hip-hop sampling as provided by the input signal 440. Thus, the spike counts generated by the liquid layer spiking neurons 460(a-n) may differentiate sufficiently per temporal signal provided by the input signal 440 such that the liquid layer 420 may differentiate between the data patterns included in the different temporal signals as provided by the input signal 440.

The data pattern as classified in the time domain by the input layer 440 enables the liquid layer spiking neurons 460(a-n) to then spike when the data included in each of the classifications are present. For example, the liquid layer spiking neurons 460(a-n) may spike when the data included in the data pattern classified in the low frequency range is identified. The liquid layer spiking neurons 460(a-n) may spike when the data included in the data pattern classified in the medium frequency range is identified. The liquid layer spiking neurons 460(a-n) may spike when the data included in the data pattern classified in the high frequency range is identified. The count of each spike of the liquid layer spiking neurons 460(a-n) during the duration of time by the liquid layer 420 then transforms the initial input signal 440 which is a single data stream in the time domain into a pattern of spike counts which may be mapped into an array of data that is similar to pixel data generated by the static images of an object that are then provided into the conventional deep neural networks such as CNN and SNN. The spike counts of the liquid layer spiking neurons 460(a-n) for the duration of time as mapped into the array of data may identify the presence of the data included in the data stream of the input signal 440 in the time domain but does so by transforming the presence of the data included in the data stream into the array of data that may then be recognized by the output layer 430.

The spike counts of the liquid layer spiking neurons 460(a-n) for the duration of time as mapped into the array of data may enable the output layer 430 to capture what is occurring in the data stream of the input signal 440 over the duration of time and then map the recognition of the data stream of the input signal 440 into single binary output 480. The spike counts of each of the liquid layer spiking neurons 460(a-n) may be mapped to a plurality of neurons 470(a-n), where n is an integer equal to or greater than one, included in the output layer 430. For example, the output layer includes 100 output neurons 470(a-n) in which then each of the 100 output neurons 470(a-n) includes a different spike count associated with a different liquid layer spiking neuron 460(a-n). In doing so, the array of data generated by the spike counts of each of the liquid layer spiking neurons 460(a-n) as provided by the liquid layer 420 is fed into the single layer of 100 output neurons 470(a-n). The output layer 430 may then generate the single binary output 480 in which the single binary output 480 may identify the temporal signal for the duration of time as provided by the input signal 440.

For example, three different audio samplings in Musical Instrumental Digital Interface (MIDI) are subject to be identified by the analog neuromorphic liquid state configuration 400. The first sampling is classical, the second sampling is ragtime, and the third sampling is hip-hop. In such an example, the classical sampling is a temporal signal that lasts for the duration of time, the ragtime sampling is a temporal signal that lasts for the duration of time, and the hip-hop signal is a temporal signal that lasts for the duration of time. Initially, the classical sampling is provided to the input layer 410 via the input signal 440. The input layer 410 classifies the data stream of the classical sampling in the time domain to bifurcate the data stream of the classical sampling into a low frequency range, a medium frequency range, and a high frequency range. In doing so, the data patterns of the classical sampling in the low frequency range are associated with the first set of input layer spiking neurons 450(a-n), the data patterns of the classical sampling in the medium frequency range are associated with the second set of input layer spiking neurons 450(a-n), and the data patterns of the classical sampling in the high frequency range are associated with the third set of input layer spiking neurons.

As a result, the first set of input layer spiking neurons spike when the data included in the data patterns of the classical music sampling in the low frequency range are present, the second set of input layer spiking neurons spike when the data included in the data patterns of the classical music sampling in the medium frequency range are present, and the third set of input layer spiking neurons spike when the data included in the data patterns of the classical music sampling in the high frequency range are present. However, the input layer spiking neurons as classified for the low frequency range, medium frequency range, and the high frequency range of the ragtime and hip-hop trigger different spiking neurons to spike based on having different data patterns present in each of the classifications of the low frequency range, medium frequency range, and the high frequency range. In doing so, each of the classical sampling, ragtime sampling, and hip-hop sampling have different data patterns in each of the classifications thereby triggering different input layer spiking neurons to spike due to the difference in data patterns of the classical sampling, ragtime sampling, and the hip-hop sampling in each of the classifications.

Continuing with this example, the input layer spiking neurons spike in each of the classifications of the low frequency range, medium frequency range, and the high frequency range to indicate the presence of the data included in the data patterns of the classical sampling in each of the classifications. Such spiking of the input layer spiking neurons 460(a-n) for each of the classifications is then provided to the liquid layer 420. The liquid layer 420 may then count the spikes generated by each of the liquid layer spiking neurons 460(a-n) for the duration of time for each classification. Rather than having to interpret the data pattern of the temporal signal that is time varying included in the initial input signal 440 that provides the classical sampling, the liquid layer 420 may now identify the data patterns now included in each classification of the classical sampling as provided by the input layer spiking neurons 460(a-n). In doing so, each of the corresponding liquid layer spiking neurons 460(a-n) may spike to indicate the presence of the data included in the data patterns of the classical sampling in the low frequency range. Each of the corresponding liquid layer spiking neurons 460(a-n) may spike to indicate the presence of the data included in the data patterns of the classical sampling in the medium frequency range. Each of the corresponding liquid layer spiking neurons 460(a-n) may spike to indicate the presence of the data included in the data patterns in the high frequency range.

The count of each of the liquid layer spiking neurons 460(a-n) in each classification may then be indicative as to the data patterns present in each classification of the classical sampling. Rather than having to interpret the entire data pattern included in the input signal 440 of the classic sampling, the classification of the classical sampling enables the count of each of the liquid layer spiking neurons 460(a-n) that spike each classification to identify the data patterns present in the classical sampling in each classification. In such an example, the count of the liquid layer spiking neurons 460(a-n) in the low frequency range identify the presence of the data pattern in the low frequency range of the classical sampling. The count of the liquid layer spiking neurons 460(a-n) in the medium frequency range identify the presence of the data pattern in the medium frequency range of the classical sampling. The count of the liquid spiking neurons 460(a-n) in the high frequency range identify the presence of the data pattern of the high frequency range of the classical sampling.

With regard to the ragtime sampling and the hip-hop sampling, classifications of the ragtime sampling and the hip-hop sampling differentiate from the classical sampling in a manner such that that the count of each sampling in each of the classifications in the liquid layer 420 different sufficiently such that the counts generated by the liquid layer 420 for each sampling enables the identification of each sampling. For example, the data patterns of the ragtime sampling and the hip-hop sampling trigger different quantity of liquid layer spiking neurons 460(a-n) to spike in each classification thereby generating a count of liquid layer spiking neurons 460(a-n) in each classification that sufficiently differentiate from the count of liquid layer spiking neurons 460(a-n) that spike for each classification of the classical sampling. As a result, the counts of the liquid layer spiking neurons 460(a-n) for the classical sampling may be sufficiently different from the counts of the liquid layer spiking neurons 460(a-n) for the ragtime and hip-hop sampling thereby enabling the counts of the liquid layer spiking neurons 460(a-n) for the classical sampling to identify the classical sampling.

The spike counts of the liquid layer spiking neurons 460(a-n) for the classical sampling for the duration of time is then mapped into an array of data identifying the classical sampling to enable the output layer 430 to identify the data pattern of the data stream included in the input signal 440 of the classical sampling. The spike counts of each of the liquid layer spiking neurons 460(a-n) are mapped to the plurality of neurons 470(a-n) included in the output layer 430. Based on the array of data mapped to the spiking neurons 460(a-n) as provided by the spike counts of the liquid layer spiking neurons 460(a-n) that spiked when identifying the classical sampling, the output layer 430 may then generate the single binary output 480 in which the single binary output 480 identifies the input signal 440 as the classical sampling. The difference in the spike counts provided by the liquid layer spiking neurons 460(a-n) of the liquid layer 420 for the classical sampling as compared to the ragtime sampling and the hip-hop sampling as mapped to the neurons 470(a-n) of the output layer 430 enables the output layer 470(a-n) to generate a single binary output 480 in which the single binary output 480 identifies the input signal 440 as the classical sampling as compared to the ragtime sampling and the hip-hop sampling.

The above example is with regard to the identification of MIDI sampling. However, the analog neuromorphic liquid state configuration 400 may be incorporated into numerous different examples and applications. For example, the analog neuromorphic liquid state configuration 400 may be incorporated to identify the presence of unmanned aerial vehicles (UAVs) that are located in an area based on the recognition of the audio samples as the input signal 440 generated by the UAVs. The audio samples of the area may be input into the analog neuromorphic liquid state configuration 400 as the input signal 440 and the analog neuromorphic liquid state configuration 400 may thereby identify whether the audio samples include the presence of UAVs in the area. In another example, the analog neuromorphic liquid state configuration 400 may identify objects captured by event based cameras in which event based cameras capture changes as to what the lens captures. The output pixels of the event based cameras capture changes in the lens which triggers changes in the pixels. Such sampling of the pixels may be input into the analog neuromorphic liquid state configuration 400 as the input signal 440 and the analog neuromorphic liquid state configuration 400 may thereby identify the pixel samples to determine the object captured by the event based camera.

In another example, the analog neuromorphic liquid state configuration 400 may be incorporated into a vibration sensor positioned on a bridge to identify whether the bridge is behaving in a structural unsound manner by identifying the vibration samples generated by the vibration sensor. In another example, the analog neuromorphic liquid state configuration 400 may be incorporated into identifying a traffic pattern based on the traffic pattern samples provided to the analog neuromorphic liquid state configuration 400. The analog neuromorphic liquid state configuration 400 may be incorporated into sensors, such as aircraft sensors and/or transportation sensors. The analog neuromorphic liquid state configuration 400 may be incorporated into stock market data. The analog neuromorphic liquid state configuration 400 may be incorporated into health analytics data such as an electrocardiogram (ECG) signal. The analog neuromorphic liquid state configuration 400 may be incorporated into any time varying application such as audio sampling, sensor output sampling, and/or any other time varying application that will be apparent to those skilled in the art relevant art(s) without departing from the spirit and scope of the disclosure.

In an embodiment, the analog neuromorphic liquid state configuration 400 may convert the input signal 440 into spike trains based on the input layer 410 that includes the plurality of input layer spiking neurons 450(a-n). Also, to project the spike trains to the liquid layer 420, an input weight matrix may be defined with randomly generated values with a varied degree of sparsity. The liquid layer 420 follows the input layer 410 and may map the input space to a higher-dimensional output space. Similarly, the liquid layer 420 includes the plurality of liquid layer spiking neurons 450(a-n). Two types of liquid layer spiking neurons 450(a-n) may be included within the liquid layer 420: excitatory (E) and inhibitory (I). Excitatory neurons promote the generation of action potentials, whereas inhibitory neurons prevent them. In neural networks, it has been found that the probability of a connection between two neurons decreases exponentially with distance. Therefore, in the liquid layer 420, the connections between neurons are initialized according to the Euclidean distance between them. The chance that two neurons connect is calculated by Eq. (1). In (1), D(i,j) is the Euclidean distance between neurons i and j with different coordinates in the x, y, and z dimensions, which is calculated by Eq. (2). The value of k is a control parameter that regulates the balance between connections:

$${P}_{c onnect} = C * {e}^{( {\frac{- D ( i , j )}{λ}}^{2} )} \qquad ( 1 )$$

$$D ( i , j ) = \sqrt{{( {x}_{i} - {x}_{j} )}^{2} + {( {y}_{i} - {y}_{j} )}^{2} + {( {z}_{i} - {z}_{j} )}^{2}} . \qquad ( 2 )$$

The parameter C is a constant whose value is set depending on the types of neurons that are forming a connection. For connections from an excitatory (E) neuron to an inhibitory (I) neuron, C=0.3. For an I to E connection, C=0.4, for E to E, C=0.3, and for I to I, C=0.1. These values are based on where synaptic activity in cortical brain tissue was measured. Assigning weights according to (1) results in a neuron topology that resembles a small-world network, containing many local connections and few global connections. A non-linear, small-world network can contain chaotic features when presented with time delayed information.

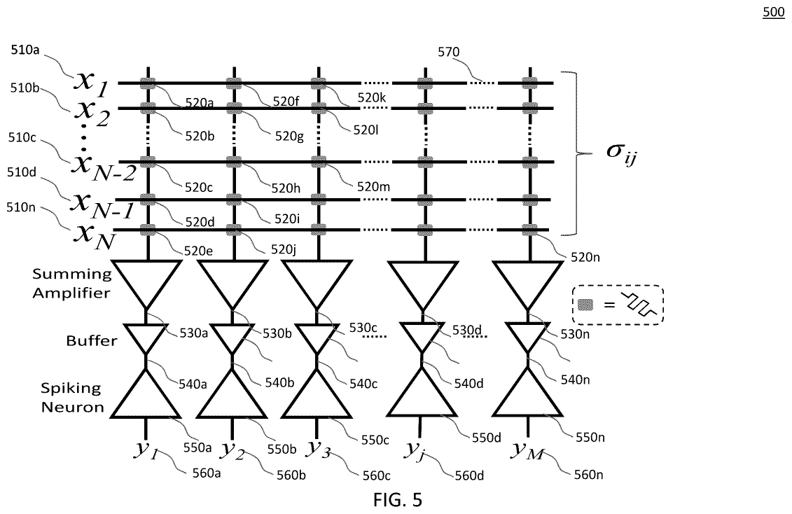

Referring to FIG. 5, in which like reference numerals are used to refer to like parts, a detailed input layer configuration 500 is shown. The input layer configuration 500 shares many similar features with the analog neuromorphic processing device 100, the analog neuromorphic circuit 200, the neural network configuration 300, and the analog neuromorphic liquid state configuration 400; therefore, only the differences between the input layer configuration 500 and the analog neuromorphic processing device 100, the analog neuromorphic circuit 200, the neural network configuration 300, and the analog neuromorphic liquid state configuration 400 are to be discussed in more detail.

As discussed above, the input layer 410 may classify an input signal 440 that includes a temporal signal for a duration of time into different classifications such that the data pattern included in each classification may be bifurcated and then applied to the input layer spiking neurons 450(a-n). In doing so, each input layer spiking neuron 450(a-n) associated with each classification spikes when the data pattern included in each classification of the input signal 440 is present. As a result, each of the input layer spiking neurons 450(a-n) may be encoded to spike based on the presence of the data pattern included in each classification is present.

The input layer configuration 500 is a detailed embodiment of the encoding layer 410. The input layer configuration 500 may be configured to encode a plurality of input layer spiking neurons 550(a-n), where n is an integer equal to or greater than one, based on a plurality of encoding signals 540(a-n), where n is an integer equal to or greater than one, generated from a plurality of input voltages 510(a-n), where n is an integer equal to or greater than one, applied to input layer configuration 500 via an input layer resistive memory crossbar configuration 570 thereby encoding each input layer spiking neuron 550(a-n) to spike when each input layer spiking neuron is increased above an input layer spiking voltage threshold. The encoding signal applied to each input layer spiking neuron 550(a-n) that is increased above the input spiking threshold is indicative of a temporal signal for a duration of time.

The input signal 440 that is applied to the input layer 410 as discussed above may be bifurcated into the plurality of input voltages 510(a-n), where n is an integer equal to or greater than one, such that the plurality of input voltages 510(a-n) are indicative of the temporal signal for the duration of time provided by the input signal 440. The input signal 440 may be bifurcated into a grid of data such that the grid of data represents the data pattern of the input signal 440 for the time sample of the duration of time. The bifurcation of the input signal into the grid of that represents the data pattern of the input signal 440 for the duration of time enables the data pattern to be applied to an input layer resistive memory crossbar configuration 570 via the grid of data. In doing so, the grid of data may be applied to the input layer resistive memory crossbar configuration 570 as the plurality of input voltages 510(a-n) such that the input voltages provide the grid of data in which the grid of data is indicative of the data patterns for the duration of time included in the temporal signal as provided by the input signal 440.

For example, the temporal signal for the duration of time that is the classical sample has a data pattern for the duration of time in which that data pattern may be classified into different classifications such as different frequency ranges. In such an example, the classical sample may be generated in a MIDI file in which the MIDI file has approximately 50 notes that may be generated by a keyboard. The input signal 440 that provides the temporal signal of the classical sample for the duration of time with the data pattern for the classical sample is bifurcated into a grid of data that represents 50 different inputs. The grid of data of 50 different inputs represents each note played by the keyboard during the duration of time. As a result, the grid of data that represents each pattern of notes played from the 50 different notes that may be generated by the keyboard during the time sample of the duration of time is converted into the input voltages 510(a-n) that are then applied to the input layer configuration 500 via the input layer resistive memory crossbar configuration 570.

The input voltages 510(a-n) applied to the input layer resistive memory crossbar configuration 570 may propagate through a plurality of input resistive memories 520(a-n), where n is an integer equal to or greater than one, thereby generating the plurality of encoding signals 540(a-n). Each weight of each input layer resistive memory 520(a-n) may be adjusted to generate the plurality of encoding signals 540(a-n) that is indicative of the temporal pattern for the duration of time. As discussed above, the temporal signal for the duration of time provided by the input signal 440 has the data pattern included in the input signal 440 bifurcated from a single data stream for the duration of time to a multi-channel input in which the data pattern is bifurcated into the grid of data and transformed into the input voltages 510(a-n) as applied to the input layer resistive memory crossbar configuration 570. In doing so, the data pattern of the single data stream of the input signal 440 bifurcated into the multi-channel input of the input voltages 510(a-n) enables the data pattern of the input signal 440 for the duration of time to be converted into signals that the input layer spiking neurons 550(a-n) may understand. The input layer spiking neurons 550(a-n) cannot spike based on a temporal signal applied to the input spiking neurons 550(a-n) for the duration of time.

However, the input layer spiking neurons 550(a-n) may spike when the data pattern of the input signal 440 is bifurcated into a multi-channel input, such as the input voltages 510(a-n), which represent the data pattern of the single data stream provided by the input signal 440 as converted from the grid of data of the data pattern. As a result, the input resistive memories 520(a-n) may be positioned in the input layer resistive memory crossbar configuration 570 such that the input voltages 510(a-n) when applied to the input layer resistive memory crossbar configuration 570 propagate through the input resistive memories 520(a-n) thereby generating a plurality of input layer output voltages 530(a-n) at the output of each column of the input layer resistive memory crossbar configuration 570.

The weight of each input layer resistive memory 520(a-n) may be adjusted such that the input voltages 510(a-n) that propagate through the resistive memories 520(a-n) apply the appropriate weights to the input voltages 510(a-n) to generate the input layer output voltages 530(a-n), where n is an integer equal to or greater than one, that represent the data pattern of the temporal signal for the duration of time as provided by the input signal 440. In doing so, the corresponding input layer spiking neurons 550(a-n) may then appropriately spike based on the input layer output voltages 530(a-n) to indicate the presence of the data pattern of the temporal signal for the duration of time as provided by the input signal 440. As result, each corresponding input layer spiking neuron 550(a-n) may spike when the presence of each bifurcated data pattern into the multi-channel inputs of the input voltages 510(a-n) are present based on the input layer output voltages 530(a-n) thereby indicating the presence of each bifurcated data pattern of the temporal signal for the duration of time provided by the input signal 440.

The input layer configuration 500 may classify each encoding signal 540(a-n) based on the weights of each input layer resistive memory 520(a-n) as applied to each corresponding input layer spiking neuron 550(a-n) as the plurality of input voltages 510(a-n) propagate through the plurality of input resistive memories 520(a-n) thereby triggering each corresponding input layer spiking neuron 550(a-n) to spike when the corresponding encoding signal 540(a-n) applied to each corresponding input layer spiking neuron 550(a-n) is increased above the input layer spiking threshold. A combination of input layer spiking neurons 550(a-n) that spike generates a plurality of input layer spiking neuron voltages 560(a-n), where n is an integer equal to or greater than one, that is indicative of the temporal signal for the duration of time.

The input layer output voltages 530(a-n) as generated from the propagation of the input voltages 510(a-n), where n is an integer equal to or greater than one, through the input layer resistive memories 520(a-n) of the input layer resistive memory crossbar configuration 570 may be converted by each corresponding buffer to a corresponding encoding signal 540(a-n). Each encoding signal 540(a-n) is a signal that represents each corresponding input layer output voltage 540(a-n) but in a manner that each corresponding input layer spiking neuron 550(a-n) may receive each corresponding encoding signal 540(a-n) and then trigger a spike when the corresponding encoding signal 540(a-n) increases above the input layer spiking threshold thereby triggering the corresponding input layer spiking neuron 550(a-n) to spike. For example, each input layer output voltage 530(a-n) may be converted to a current signal by each corresponding buffer should the input layer spiking neurons 550(a-n) require a current signal as compared to a voltage signal to spike. Thus, each weight for each input layer resistive memory 520(a-n) may be adjusted such that when applied to the input voltages 510(a-n) generate the input layer output voltages 530(a-n) that when converted to each corresponding encoding signal 540(a-n) trigger the corresponding input layer spiking neurons 550(a-n) to spike when the data pattern of the temporal signal for the duration time as provided by the input signal 440 is present.

Each encoding signal 540(a-n) may then be classified in a similar manner as discussed generally above regarding the input signal 440 such that each encoding signal 540(a-n) represents the data pattern for each section of the temporal signal for the duration of time as provided by the input signal 440. In doing so, each encoding signal 540(a-n) provides the presence of the data pattern for each section of the classified input signal 440 to each corresponding input layer spiking neuron 550(a-n). Each corresponding input layer spiking neuron 550(a-n) may then spike when the corresponding encoding signal 540(a-n) increases above the input layer spiking threshold thereby triggering the corresponding input layer spiking neuron 550(a-n) to spike. Each encoding signal 540(a-n) increases above the input layer spiking threshold when the data pattern for the corresponding classification that is provided by the corresponding encoding signal 540(a-n) is present. As a result, the encoding signal 540(a-n) increases above the input layer spiking threshold when the data pattern in which the encoding signal 540(a-n) is classified is present thereby trigging the corresponding input layer spiking neuron 550(a-n) to spike indicating the presence of the data pattern in the encoding signal 540(a-n). The encoding signal 540(a-n) fails to increase above the input layer spiking threshold when the data pattern in which encoding signal 540(a-n) is classified is not present thereby failing to trigger the corresponding input layer spiking neuron 550(a-n) to not spike indicating that the data pattern is not present in the encoding signal 540(a-n).

For example, the classical stream provided by the MIDI file as a single data stream provided by the input signal 440 may be bifurcated into a multi-channel input based on the classification of the data pattern of the single data stream into bifurcated data patterns based on the low frequency range, medium frequency range, and the high frequency range. The multi-channel input is then bifurcated based on frequency into the input voltages 510(a-n) that propagate through the input resistive memories 520(a-n) and generate input layer output voltages 530(a-n) that are converted to encoding signals 540(a-n). For each frequency range, each corresponding encoding signal 540(a-n) may then increase above the input layer spiking threshold thereby causing the corresponding input spiking neuron 550(a-n) to spike when a note in the data pattern of the classical stream is present in the frequency range of the corresponding encoding signal 540(a-n). As a result, each input layer spiking neuron 550(a-n) that spikes is indicative of a note present in the data pattern of the low frequency range, medium frequency range, and/or high frequency range when each corresponding input layer spiking neuron 550(a-n) spikes in each frequency range due to the corresponding encoding signal 540(a-n) classified for each corresponding frequency range.

As a result, each input layer spiking neuron 550(a-n) that spikes may generate a corresponding input layer spiking neuron voltage 560(a-n) in which the input layer spiking neuron voltages 560(a-n) generated by the input layer spiking neurons 550(a-n) that spiked is indicative of the temporal signal for the duration of time as provided by the input signal 440. In doing so, the input layer spiking neurons 550(a-n) may be encoded such that the input layer spiking neurons 550(a-n) spike when the data pattern of each classification of the input signal 440 is present. The input layer spiking neuron voltages 560(a-n) may be binary signals that indicate whether corresponding spiking neuron 550(a-n) spikes or does not spike. The binary signal of the input layer spiking neuron voltages 560(a-n) thereby enables the input resistive memories 520(a-n) included in the input layer resistive memory crossbar configuration 570 to be positive weights and the input voltages 510(a-n) to be positive values in which the input layer resistive memory crossbar configuration 570 may be simplified due not having negative weights. Thus, the input layer spiking neurons 550(a-n) recognize when each data pattern for each classification of the input signal 440 is present and may then provide the input layer spiking neuron voltages 560(a-n) indicating that recognition to the liquid layer 420.

In an embodiment, the input layer 410 and the liquid layer 420 may be a leaky integrate-and-fire (LIF) spiking neuron model, where α=0.7, λ=0.12, and R=0.32. The behavior of this neuron model is shown by Eq. (3). A neuron accumulates a voltage equal to the dot product between all of its inputs and the corresponding synaptic weight for each, denoted as x(t). Each cycle this potential gets reduced by a leak value γ. If the potential of the neuron becomes greater than a predefined threshold a, a spike is fired and the potential is reset to the value R:

Vᵢ(t)=Vᵢ(t−1)+x(t)−γ. (3)

In an embodiment, the LSM algorithm may be mapped onto the input layer resistive memory crossbar configuration 570 including the input layer resistive memories 520(a-n) as discussed in detail above, a liquid layer resistive memory crossbar configuration as discussed in detail below, and the output layer resistive memory crossbar configuration as discussed in detail below. The conductance values of the resistive memories represent the weights of in the LSM algorithm, and the column amplifiers aid in the dot product computations and voltage scaling to ensure outputs are equivalent to those produced in software. If a weight matrix contains only positive values, such as the input layer resistive memories 520(a-n) included in the input layer resistive memory crossbar configuration 570, the weight matrix will be scaled and normalized to the minimum and maximum conductance of the resistive memory crossbar configurations utilized as in equation (4):

$$σ = \frac{{σ}_{o n} - {σ}_{o f f}}{max ( \vert W \vert )} W + {σ}_{o f f} . \qquad ( 4 )$$

When a weight matrix contains both positive and negative values, two resistive memory per weight element are used. Therefore, each weight matrix W in the LSM algorithm must be transformed into two different matrices, W⁺ and W⁻. The positive weight matrix, W⁺ contains positive non-zero elements in every location where the weight is greater than zero and zeros in the other locations. The negative weight matrix, W⁻, contains positive non-zero elements in each location where there is a negative value, and zeroes in all other locations. Each weight must then be converted to a number that is within the range of the conductance of the resistive memory devices. Equations (5) and (6) show how W+ and W− can be scaled to a bounded range of conductance values set according to physical resistive memory device limits:

$${σ}_{p o s} = \frac{{σ}_{o n} - {σ}_{o f f}}{max ( \vert W \vert )} {W}^{+} + {σ}_{o f f} \qquad ( 5 )$$

$${σ}_{n e g} = \frac{{σ}_{o n} - {σ}_{o f f}}{max ( \vert W \vert )} {W}^{-} + {σ}_{o f f} . \qquad ( 6 )$$

A summing amplifier may then be used to sum all the voltage×conductance multiplications to complete the dot product (see Eq. (7)). Setting the feedback resistance Rf according to Eq. (8) sets a gain on the summing amplifier that produces an output voltage proportional to the software dot product for a given neuron. This method training in hardware and download weights to the resistive memory crossbar configuration to obtain a similar result in hardware. The output will be a negative voltage, but this will be reversed due to a following buffer stage within the circuit:

$${y}_{j}^{-} = - {R}_{f} {Σ}_{i = 1}^{N} ( {x}_{i} {σ}_{i j}^{+} - {x}_{i} {σ}_{i j}^{-} ) \qquad ( 7 )$$

$${R}_{f} = \frac{max ( W )}{{σ}_{o n} - {σ}_{o f f}} \qquad ( 8 )$$

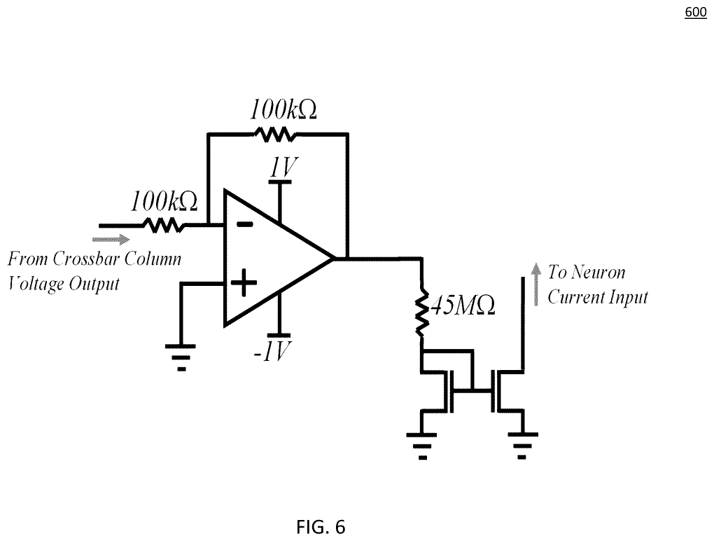

In an embodiment, to drive the input layer spiking neurons 550(a-n) with the summing amplifier outputs for each column of the input layer resistive memory crossbar configuration 570 in the resistive memory-based dot product circuits, a voltage to current converter 600 may be used. The voltage to current converter 600 depicted in FIG. 6 may decouple the column impedance of the input layer resistive memory crossbar configuration 570 from the current mirror input, and may allow a linear change in column amplifier voltage output to produce a linear change in neuron current input. Any type of converter to drive the input layer spiking neurons 550(a-n) may be incorporated that will be apparent to those skilled in the relevant art(s) without departing from the spirit and scope of the disclosure.

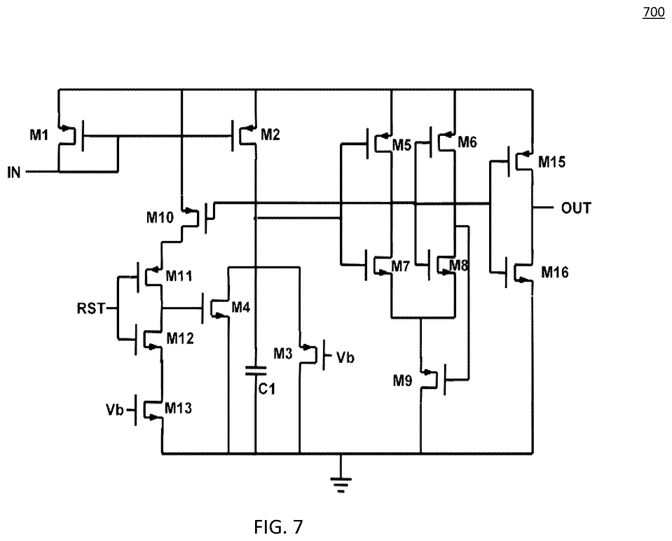

In an embodiment, the neuron circuit configuration 700 depicted in FIG. 7 includes a current mirror (M1-M2) used to inject the input current into the capacitor, C1 where the current is integrated and then leaked through the resistance produced by M3. The spike generation of the circuit is implemented through a Schmitt trigger. When the membrane potential reaches the threshold of the Schmitt trigger, the output node between M6 and M8 returns the drain supply voltage and the reset component of the circuit at M10 is turned on. The potential is reset to ground through M4. Any type of neuron circuit may be implemented for the input layer spiking neurons 550(a-n) may be incorporated that will be apparent to those skill in the art relevant art(s) without departing from the spirt and scope of the disclosure.

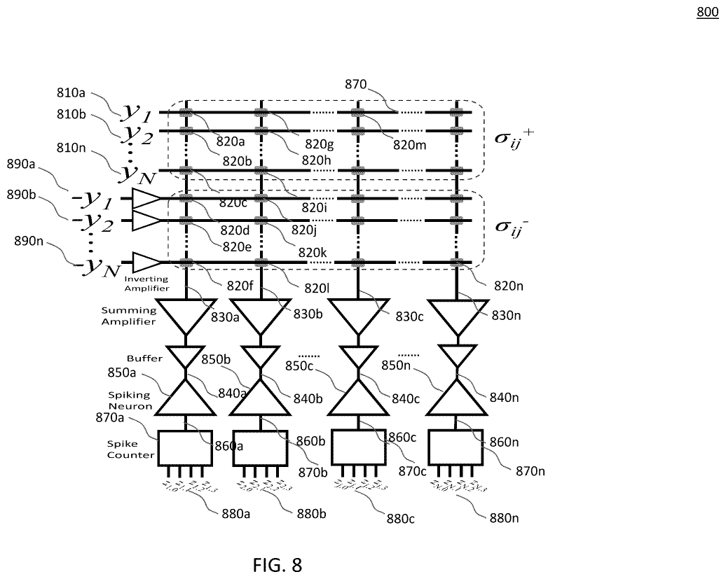

Referring to FIG. 8, in which like reference numerals are used to refer to like parts, a detailed liquid layer configuration 800 is shown. The liquid layer configuration 800 shares many similar features with the analog neuromorphic processing device 100, the analog neuromorphic circuit 200, the neural network configuration 300, the analog neuromorphic liquid state configuration 400, and the input layer configuration 500; therefore, only the differences between the liquid layer configuration 800 and the analog neuromorphic processing device 100, the analog neuromorphic circuit 200, the neural network configuration 300, the analog neuromorphic liquid state configuration 400, and the input layer configuration 500 are to be discussed in more detail.

As discussed above, the liquid layer 420 may count the spikes generated by the liquid layer spiking neurons 460(a-n) for the duration of time in which the count of spikes of the liquid layer spiking neurons 460(a-n) may identify the temporal signal for the duration of time as provided by the input signal 440. Based on the encoding of the input layer spiking neurons 450(a-n) that have been classified to bifurcate the data pattern of the temporal signal for the duration of time as provided by the input signal 440, the liquid layer spiking neurons 460(a-n) may also be classified and thereby each liquid layer spiking neuron 460(a-n) that spikes as classified indicates the presence of the corresponding classified data pattern of the input signal 440. As a result, the count of each liquid layer spiking neuron that counts the presence of classified data pattern enables such count to indicate the temporal signal for the duration of time provided by the input signal 440.

The liquid layer configuration 800 is a detailed embodiment of the embodiment of the liquid layer 420. The liquid layer configuration 800 may be configured to count each spike generated by a plurality of liquid layer spiking neurons 850(a-n), where n is an integer equal to or greater than one for the duration of time based on a plurality of liquid layer signals 840(a-n) generated from a plurality of input layer spiking neuron voltages 810(a-n), where n is an integer equal to or greater than one, and 890(a-n), where n is an integer equal to the quantity of 810(a-n) generated from each input layer spiking neuron 550(a-n) based on the plurality of input layer spiking neuron voltages 810(a-n) and 890(a-n) applied to the liquid layer configuration 800 via a liquid layer resistive memory crossbar configuration 870 thereby triggering each liquid layer spiking neuron 850(a-n) to spike when the corresponding liquid layer signal 840(a-n) is increased above a liquid layer spiking voltage threshold. Each spike generated by the plurality of liquid layer spiking neurons 850(a-n) for the duration of time that is generated is indicative of the temporal signal for the duration of time.

As discussed in detail above, the input layer spiking neuron voltages 810(a-n) and 890(a-n) generated by the input layer spiking neurons 550(a-n) provide the input layer spiking neurons 550(a-n) that spiked based on the presence of the bifurcated data pattern that is generated from the classification of the data pattern of the input signal 440. In doing so, the input spiking neurons 550(a-n) may be encoded such that the input layer spiking neuron voltages 810(a-n) and 890(a-n) may represent the presence of the bifurcated data pattern in for each corresponding class of the data pattern of the input signal 440. As a result, the input layer spiking neuron voltages 810(a-n) and 890(a-n) may then be applied to the liquid layer resistive memory crossbar configuration 870 such that the liquid layer configuration 800 may then identify the temporal signal for the duration of time as provided by the input signal 440.

The liquid layer configuration 800 may propagate the plurality of input layer spiking neuron voltages 810(a-n) generated from the plurality of input layer spiking neurons 550(a-n) and propagate the plurality of input layer spiking neuron voltages as a corresponding negative inverted value 890(a-n) of each input layer spiking neuron voltages 810(a-n) as applied to the liquid layer resistive memory crossbar configuration 870 through a plurality of liquid layer resistive memories 820(a-n) positioned in the liquid layer resistive memory crossbar configuration 870 thereby generating the plurality of liquid layer signals 840(a-n). The input layer spiking neuron voltages 890(a-n) may be the negative inverted value of the input layer spiking neuron voltages 810(a-n). As discussed above, the input layer spiking neuron voltages 810(a-n) generated from the input layer spiking neurons 550(a-n) may be a binary signal 880(a-n) in which the corresponding input layer spiking neuron 550(a-n) spiked or did not spike.

However, the liquid layer resistive memory crossbar configuration 870 may generate the negative inverted value of the input layer spiking neuron voltages 810(a-n) to generate the input layer spiking neuron voltages 890(a-n). In doing so, the liquid layer resistive memory crossbar configuration 870 may generate negative values of the input layer spiking neuron voltages 810(a-n) to propagate through resistive memory crossbar configuration 870 without having to adjust any of the weights of the liquid layer resistive memories 820(a-n) to have negative weights. Rather, the weights of the liquid layer resistive memories 820(a-n) may be positive weights that when applied to the negative inverted value of the input layer spiking neuron voltages 890(a-n) may generate negative values in addition to the positive values of the input layer spiking neuron voltages 890(a-n). The input layer spiking neuron voltages 810(a-n) may be referred to include both the positive input layer spiking neuron voltages 810(a-n) and the negative inverted value of the input layer spiking neuron voltages 890(a-n) from this point on for simplicity.

In a similar manner with regard to the discussion above for the input layer configuration 500, the liquid layer resistive memories 820(a-n) may be positioned in the liquid layer resistive memory crossbar configuration 870 such that the input layer spiking neuron voltages 810(a-n) when applied to the liquid layer resistive memory crossbar configuration 870 propagate through the liquid layer resistive memories thereby generating a plurality of liquid layer output voltages 830(a-n) at the output of each column of the output layer resistive memory crossbar configuration 870. The weights of each liquid layer resistive memory 820(a-n), where n is an integer equal to or greater than one, may be adjusted such that when the input layer spiking neuron voltages 810(a-n) propagate through the liquid layer resistive memories 870 to generate the liquid layer output voltages 830(a-n) that such liquid layer output voltages 830(a-n) may identify the bifurcated data pattern of each classification of the input signal 440 when present in each class of the input signal 440.

The liquid layer configuration 800 may classify each liquid layer signal based on the weights of each liquid layer resistive memory 820 as applied to each corresponding liquid layer spiking neuron 850(a-n) as the plurality of input layer spiking neuron voltages 810(a-n) and each corresponding negative inverted value of each input layer spiking neuron 890(a-n) propagate through the plurality of liquid layer resistive memories 820(a-n) thereby triggering each corresponding liquid layer spiking neuron 850(a-n) to spike when the corresponding liquid layer signal 840(a-n) applied to each corresponding liquid layer spiking neuron 850(a-n) is increased above the liquid layer spiking voltage threshold. A count of the liquid layer spiking neurons 850(a-n) that spike for the duration of time generates the plurality of counting voltages that is indicative of the temporal signal for the duration of time.

In a similar manner with regard to the discussion above for the input layer configuration 500, each liquid layer signal 840(a-n) may then be classified such that each liquid layer signal 840(a-n) represents the data pattern for section of the temporal signal for the duration of time for the input signal 440 as encoded by the input layer configuration 500. In doing so, each liquid layer signal 540(a-n) provides the presence of the data pattern for each section of the classified input signal 440 as encoded by the input layer configuration 500 to each corresponding liquid layer spiking neuron 850(a-n). Each corresponding liquid layer spiking neuron 850(a-n) may then spike when the corresponding liquid layer signal 840(a-n) increases above the liquid layer spiking threshold thereby trigging the corresponding liquid layer spiking neuron 550(a-n) to spike. Each liquid layer signal 550(a-n) increases above the liquid layer spiking threshold when the data pattern for the corresponding classification that is provided by the liquid layer signal 840(a-n) is present as encoded by the input layer configuration 500. As a result, the liquid layer signal 840(a-n) increases above the liquid layer spiking threshold when the data pattern in which liquid layer signal 840(a-n) is classified is present thereby triggering the corresponding liquid layer spiking neuron 850(a-n) to spike indicating the presence of the data pattern in the liquid layer signal 840(a-n) as encoded by the input layer configuration 500. The liquid layer signal 840(a-n) fails to increase above the liquid layer spiking threshold when the data pattern in which the liquid layer signal 840(a-n) is classified is not present thereby failing to trigger the corresponding liquid layer spiking neuron 840(a-n) to not spike indicating that the data pattern is not present in the liquid layer signal 840(a-n) as encoded by the input layer configuration 500.

Thus, the liquid layer spiking neurons 850(a-n) may generate counting voltages in which the counting voltages indicate the count of which each time the corresponding liquid layer spiking neurons 850(a-n) spiked for the duration of time. Each liquid layer spiking neuron 850(a-n) may be classified based on the encoding of the input layer configuration 500 in which each liquid spiking neuron 850(a-n) may spike when the bifurcated data pattern of the input signal 440 is present in the classified portion of the input signal 440 for the duration of time. As a result, the count of each time the liquid spiking neurons 850(a-n) may spike for each classified portion of the input signal 440 may identify the temporal signal for the duration of time.

For example, the liquid layer spiking neurons 850(a-n) associated with the low frequency range of the temporal for the duration of time as provided by the input signal 440 may spike when the data pattern of the input signal 440 for the low frequency range of the input signal 440 is present. In doing so, the count of each spike of the spiking neurons associated with the low frequency range of the temporal signal may indicate the presence of the data pattern of the classical sampling as provided by the input signal 440. The liquid layer spiking neurons 850(a-n) associated with the medium frequency range of the temporal signal for the duration of time as provided by the input signal 440 may spike when the data pattern of the input signal 440 for the medium frequency range of the input signal 440 is present. In doing so, the count of each spike of the liquid layer spiking neurons 850(a-n) associated with the medium frequency range of the temporal signal may indicate the presence of the data pattern of the classical sampling as provided by the input signal 440. The liquid layer spiking neurons 850(a-n) associated with the high frequency range of the temporal signal for the duration of time as provided by the input signal 440 may spike when the data pattern of the input signal 440 for the high frequency range of the input signal 440 is present. In doing so, the count of each spike of the liquid layer spiking neurons 850(a-n) associated with the high frequency range of the temporal signal may indicate the presence of the data pattern of the classical sampling as provided by the input signal 440. Thus, the counts of each spike of the liquid layer spiking neurons 850(a-n) for the duration of time for each classification of the input signal 440 may identify the temporal signal for the duration of time as provided by the input signal 440.

The liquid layer configuration 800 may generate the count of liquid layer spiking neurons 850(a-n) that spike for the duration of time when a plurality of spike counters 870(a-n) associated with each corresponding liquid layer spiking neuron 850(a-n) detects a liquid layer spiking neuron voltage 860(a-n) from each corresponding liquid layer spiking neuron 850(a-n) that spikes for the duration of time thereby triggering each spike counter 870(a-n) to generate each corresponding counting voltage that is indicative of each time each liquid layer spiking neuron 850(a-n) spiked. The counting voltages generated by each spike counter is indicative of the temporal signal for the duration of time.

As noted above, each liquid layer spiking neuron 850(a-n) may be associated with a different classification of the temporal signal for the duration of time as provided by the input signal 440. In doing so, each of the liquid layer spiking neurons 850(a-n) associated with each classification of the input signal 440 when the data pattern for each classification is present. Each liquid layer spiking neuron 850(a-n) within a specified classification may then spike above the liquid layer spiking threshold thereby generating the liquid layer spiking voltage 860(a-n). The spike counters 870(a-n) associated with the liquid layer spiking neurons 850(a-n) for each classification may then count the spikes generated by the liquid layer spiking neurons 850(a-n) for each specified class. In doing so, the spike counters 870(a-n) may provide the count of the liquid layer spiking neurons 850(a-n) that spiked for the duration of time.

The liquid layer configuration 800 may then output the counting voltages generated by each corresponding spike counter 870(a-n) as a corresponding binary signal 880(a-n) generated by each corresponding spike counter 870(a-n) that is indicative of each time each liquid layer spiking neuron 850(a-n) that is associated with each corresponding spike counter 870(a-n) spiked. Each counting voltage associated with each spike counter 870(a-n) is a binary bit that is converted into the corresponding binary signal 880(a-n) generated by each spike counter 870(a-n) thereby providing the count of spikes by each liquid layer spiking neuron 850(a-n) during the duration of time via the binary signals 880(a-n) generated by each corresponding spike counter 870(a-n). In doing so, each counting voltage generated by each spike counter 870(a-n) that indicates each time the corresponding liquid layer spiking neuron 850(a-n) spiked and the conversion of the counting voltage to a corresponding binary signal 880(a-n) may enable the binary signals 880(a-n) to be mapped to a vector matrix that indicates the count each time each liquid layer spiking neuron 850(a-n) spiked during the duration of time. Such vector matrix may then identify the temporal signal for the duration of time as provided by the input signal 440.

In an embodiment, each spike counter 870(a-n) may be a binary bit counter in which each spike counter 870(a-n) may count the spikes generated by each corresponding liquid layer spiking neuron 850(a-n). In doing so, each spike counter 870(a-n) may then generate the counting voltage which identifies the count of spikes generated by the each corresponding liquid layer spiking neuron 850(a-n). The spike counter 870(a-n) may then convert the count voltage to a corresponding binary signal 880(a-n). However, the binary signal 880(a-n) may represent the count of spikes for the corresponding liquid layer spiking neuron 850(a-n) as a binary bit value. For example, each spike counter 870(a-n) may be a 4-bit binary counter in which each spike counter 870(a-n) generates the binary signal 880(a-n) based on a 4-bit binary value in which each binary signal 880(a-n) as the 4-bit binary value is mapped to the vector matrix to identify the temporal signal for the duration of time as provided by the input signal 440. The spike counters 870(a-n) may a bit counter and/or any other type of counter that may count the spikes of the liquid layer spiking neurons 850(a-n) and provide the counting voltages and/or convert the counting voltages to corresponding signals that may be mapped to vector matrix to identify the temporal signal for the duration of time as provided by the input signal 440 that will be apparent to those skilled in the art relevant art(s) without departing from the spirit and scope of the disclosure.

Further, the circuit design for the liquid layer configuration 800 in FIG. 8 is similar to that of the input layer configuration 500. However, both positive and negative weights may be included, and thus two resistive memories 820(a-n) per synaptic weight may be included for correct operation. At each input row that leads to a resistive memory 820(a-n) denoted by the conductivity matrix σᵢⱼ⁻, an inverting amplifier may be incorporated. This is because these resistive memories 820(a-n) are meant to act as negative weights. Since resistive memories 820(a-n) may not store a negative conductivity value, a negative spike is applied to a positive conductivity value to uphold the relationship. The corresponding inverting amplifier simply has a gain of −1 to flip any spikes present into the negative regime on the corresponding rows of the liquid layer resistive memory crossbar configuration 870. Following the summing amplifier at the column output of the liquid layer resistive memory crossbar configuration 870, the liquid layer configuration 800 may also incorporate buffers and liquid layer spiking neurons 850(a-n) as discussed above in a similar manner for the input layer configuration 500. However, following each liquid layer spiking neuron 850(a-n), a corresponding spike counter 870(a-n) may also be present at each column output of the liquid layer resistive memory crossbar configuration 870 to map the temporal patterns into vectors that may be classified by a single layer perceptron.

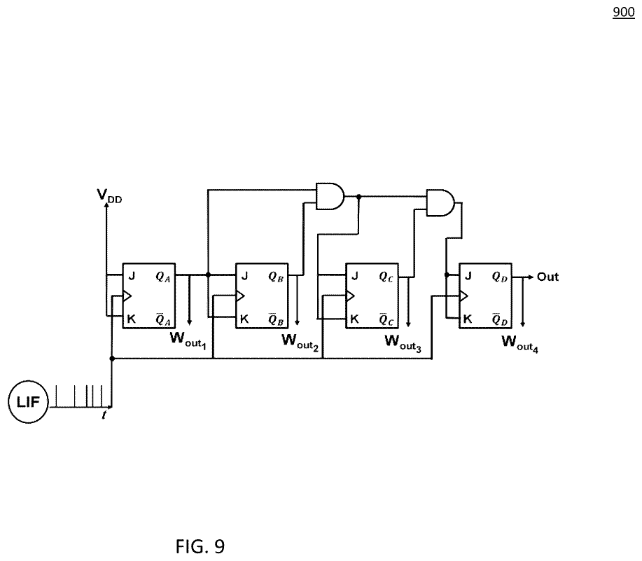

In an embodiment, the liquid layer spiking neurons 850(a-n) in the liquid layer configuration 800 may be sampled so that a time domain signal may be converted to a snapshot vector representation for perceptron classification. To do this, a series of spike counters 870(a-n) may be implemented, one for each liquid layer spiking neuron 850(a-n) in the liquid layer configuration 800. For example, each spike counter 870(a-n) is able to count from 0 to 15. Each liquid layer spiking neuron 850(a-n) in the liquid layer configuration 800 is connected to the clock input of the counter. Thus, an asynchronous spike count may be easily stored for each liquid layer spiking neuron 850(a-n). Furthermore, a state vector may be obtained by collecting the state of each spike counter 870(a-n) at a given cycle, which may then be used for classification at the output layer 430. In this embodiment the spike counter circuit configuration 900 is depicted in FIG. 9. Any type of spike counter circuit configuration to count each spike of the liquid layer spiking neurons 850(a-n) may be incorporated that will be apparent to those skilled in the relevant art(s) without departing from the spirit and scope of the disclosure.

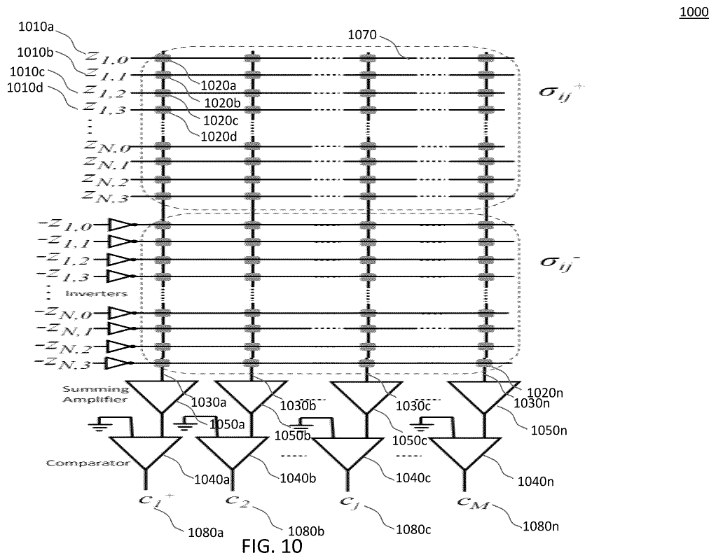

Referring to FIG. 10, in which like reference numerals are used to refer to like parts, a detailed output layer configuration 1000 is shown. The output layer configuration 1000 shares many similar features with the analog neuromorphic processing device 100, the analog neuromorphic circuit 200, the neural network configuration 300, the analog neuromorphic liquid state configuration 400, the input layer configuration 500, and the liquid layer configuration 800; therefore, only the differences between the output layer configuration 800 and the analog neuromorphic processing device 100, the analog neuromorphic circuit 200, the neural network configuration 300, the analog neuromorphic liquid state configuration 400, the input layer configuration 500, and the liquid layer configuration are to be discussed in more detail.

As discussed above, the output layer 430 may capture the data pattern of the data stream of the input signal 440 over the duration of time and then map the recognition of the data pattern of the data stream of the input signal 440 into the single binary output 480. The spike counts of each of the liquid layer spiking neurons 460(a-n) may be mapped to the output neurons 470(a-n) included in the output layer 430. In doing so, the array of data generated by the spike counts of each of the liquid layer spiking neurons 460(a-n) as provided by the liquid layer may be fed into the layer of output neurons 470(a-n). The output layer 430 may then generate the single binary output 480 in which the single binary output 480 may identify the temporal signal for the duration of time as provided by the input signal 440.

The output layer configuration 1000 is a detailed embodiment of the embodiment of the output layer 430. The output layer configuration 1000 may identify the temporal signal as provided by the input signal 440 for the duration of time based on a plurality of output voltages 1030(a-n) generated from a plurality of counting voltages 1010(a-n) generated from the count of each spike generated by the plurality of liquid layer spiking neurons 850(a-n) for the duration of time applied to the output layer configuration 1000 via the output resistive crossbar memory configuration 1070. The plurality of output voltages 1030(a-n) generated from the output resistive memory crossbar configuration 1000 is indicative of the temporal signal for the duration of time.

As discussed above, the counting voltages 1010(a-n) include the count of each liquid layer spiking neuron 850(a-n) that spiked during the duration of time in which the count of each liquid layer spiking neuron 850(a-n) that spiked may be indicate the presence of the data pattern included in each class of the input signal 440 thereby identifying the temporal signal for the duration of time. The counting voltages 1010(a-n) may then be applied to the output layer resistive memory crossbar configuration 1070 and may then propagate through the output layer resistive memory crossbar configuration 1070 thereby generating the output voltages 1030(a-n). The output voltages 1030(a-n) generated from the propagation of the counting voltages 1010(a-n) that represent the count of each liquid layer spiking neuron 850(a-n) that spiked thereby trigger the output voltages 1030(a-n) to identify the temporal signal for the duration of time as provided by the input signal 440.

However, in an embodiment discussed above, the counting voltages 1010(a-n) may be the binary signals 880(a-n) in which the spike counters 870(a-n) converted the counting voltages generated by the liquid layer resistive memory crossbar configuration 870 into the binary signals 880(a-n) in which the binary signals 880(a-n) identify the temporal signal for the duration of time as provided by the input signal 440. In such an embodiment, the counting voltages 1010(a-n) applied to the output layer resistive memory crossbar configuration 1070 may include the binary signals 880(a-n) generated from the conversion of the output voltages 1010(a-n) by the spike counters 870(a-n). Thus, the counting voltages 1010(a-n) may include the voltages generated that include the count of each liquid layer spiking neuron 850(a-n) that spiked during the duration of time as well as the binary signals 880(a-n) generated by the conversion of the counting voltages into the binary signals 880(a-n) that include the count of each liquid layer spiking neuron 850(a-n) that spiked during the duration of time. The counting voltages 1010(a-n) may include any type of signal that identifies the count of each liquid layer spiking neuron 850(a-n) that spiked as provided in a vector matrix to the output layer resistive memory crossbar configuration 1070 that will be apparent to those skilled in the relevant art(s) without departing from the spirit and scope of the disclosure.

The output layer configuration 1000 may propagate the counting voltages 1010(a-n) generated from the spike counters 870(a-n) that provide the count of each time each liquid layer spiking neuron 850(a-n) spiked during the duration of time and propagate the plurality of counting voltages 1010(a-n) as a corresponding negative inverted value of each counting voltage 1010(a-n) as applied to the output resistive memory crossbar configuration 1070 through a plurality of output layer resistive memories 1020(a-n) positioned in the output resistive memory crossbar configuration 1070 generating the plurality of output voltages 1030(a-n) that is indicative of the temporal pattern for the duration of time. Each output voltage 1030(a-n) is generated at each output column included in the output resistive memory crossbar configuration 1070.

In a similar manner to the liquid layer resistive memory crossbar configuration 870, the output resistive memory crossbar configuration 1070 may generate the negative inverted value of the each counting voltage 1010(a-n). In doing so, the output resistive memory crossbar configuration 1070 may generate negative values of the counting voltages 1010(a-n) to propagate through the output layer resistive memory crossbar configuration 870 without having to adjust any of the weights of the output layer resistive memories 1020(a-n) to have negative weights. Rather, the weights of the output layer resistive memories 1020(a-n) may be positive weights that when applied to the negative inverted value of the counting voltages 1010(a-n) may generate negative values in addition to the positive values of the counting voltages 1010(a-n). The output layer voltages 1010(a-n) may be referred to include both the positive counting voltages 1010(a-n) and the negative inverted value of the counting voltages 1010(a-n) for simplicity.

As discussed above in an embodiment, the spike counters 870(a-n) may be a binary bit counter in which each spike counter 870(a-n) may generate the binary signal 880(a-n) as a binary bit value. As discussed above in an example, each spike counter 870(a-n) may be 4-bit binary counter in which each spike counter 870(a-n) generates the binary signal 880(a-n) based on a 4-bit binary value in which each binary signal 880(a-n) is mapped to the vector matrix. In an embodiment, digital to analog converters may be included to convert the bit values provide by the binary signal 880(a-n) into a single value that represents the bit values provided by the binary signal 880(a-n) as the counting voltages 1010(a-n) to the output layer resistive memory configuration 1000. In the above example, the 4-bit signals generated by the spike counter 870(a-n) may be converted to a single value that represents 4-bit values provided by the binary signal 880(a-n).

However, in another embodiment as depicted by the output layer configuration 1000, the need for digital to analog converters is eliminated due to each bit included in each counting voltage signal 1010(a-n) may be mapped to a corresponding input of the output layer resistive memory configuration 1000. In doing so, the need to convert the bit values provide by the bit signal included in the counting voltage signal 1010(a-n) is eliminated to due to each bit value generated by each spike counter 870(a-n) being mapped directly to the inputs of the output layer resistive memory configuration 1000. Continuing with the example of the 4-bit binary counter, each of the 4-bit values as generated by a first spike counter 870a is mapped to inputs of the output layer resistive memory crossbar configuration 1070 as 1010a, 1010b, 1010c, and 1010d. Each of the 4-bit values as generated by the remaining spike counters 870(b-n) may be mapped to the inputs of the output layer resistive memory crossbar configuration 870 as counting voltages 1010(a-n) in a similar manner. Further, the negative inverted value of each 4-bit value as generated by the spike counters 870(a-n) may be mapped to the output layer resistive memory crossbar configuration 870 as the counting voltages 1010(a-n).

In a similar manner with regard to the discussion above for the input layer configuration 500 and the liquid layer configuration 800, the output layer resistive memories 1020(a-n) may be positioned in the output layer resistive memory crossbar configuration 1070 such that the counting voltages 1010(a-n) when applied to the output layer resistive memory crossbar configuration 1070 propagate through the output layer resistive memories 1020(a-n) thereby generating a plurality of output voltages 1030(a-n) at the output of each column of the output layer resistive memory crossbar configuration 1070. The weights of each output layer resistive memory 1020(a-n), where n is an integer equal to or greater than one, may be adjusted such that when the counting voltages 1010(a-n) propagate through the output layer resistive memories 1020(a-n) to generate the output voltages 1030(a-n) that such output voltages 1030(a-n) may identify the output signal 440 as converted from the time domain.

Each of the counting voltages 1010(a-n) may propagate through the output layer resistive memory crossbar configuration 1070 in which each of the counting voltages 1010(a-n) may be multiplied by each of the weights of the output layer resistive memories 1020(a-n). Each of the counting voltages 1010(a-n) that propagate through the output layer resistive memory crossbar configuration 1070 may generate multiply-add pairs generated from the simultaneous multiplication operations and add operations executed as the counting voltages 1010(a-n) propagate through the output layer resistive memory crossbar configuration 1070. Each of the multiply-add pairs may then be summed by the corresponding summing amplifier 1050(a-n), where n is an integer equal to or greater than one. Each summing amplifier 1050(a-n) may then execute the dot product on the corresponding output voltages 1030(a-n) generated from the multiply-add pairs as the counting voltages 1010(a-n) propagate through the output layer resistive memory crossbar configuration 1070.

The output layer configuration 1000 may compress each output voltage 1030(a-n) at each output of each column included in the output resistive memory crossbar configuration 1070 from the propagation of the counting voltages 1010(a-n) through the resistive memory crossbar configuration 1070 to a compressed output signal 1080(a-n), where n is an integer equal to or greater than one. Each compressed output signal 1080(a-n) is binary voltage value that represents the output voltages. The output layer configuration 1000 may identify the temporal signal for the duration of time based on a combination of each compressed output signal 1080(a-n). The combination of compressed output signals 1080(a-n) is indicative of the temporal signal for the duration of time.

Each of the output voltages 1030(a-n) may then be compressed into a binary signal by each corresponding comparator 1080(a-n), where n is an integer equal to or greater than one, after each corresponding summing amplifier 1050(a-n) executes the dot product on each of the corresponding output voltages 1030(a-n). In doing so, each comparator 1080(a-n) compresses the corresponding output voltage 1030(a-n) into a compressed output signal 1080(a-n) in which the compressed output signal 1080(a-n) may be a binary signal that may easily represent the identification of the initial input signal 440 that provides the temporal signal over the duration of time. For example, each comparator 1080(a-n) may compress each corresponding output voltage 1030(a-n) into a binary signal as provided by the compressed output signal 1080(a-n) that provides a “0” or a “1”. Each of the compressed output signals 1080(a-n) in combination may then represent the identification of the initial input signal 440 that provides the temporal signal for the duration of time.

For example, the compressed output signal 1080a may output a “1”. The compressed output signal 1080b may output a “0”. The compressed output signal 1080c may output a “0”. The compressed output signal 1080n may output a “0”. The compressed output signals 1080(a-n) of “1 0 0 0” may recognize that the input signal 440 is the classical sampling. Further, the compressed output signals 1080(a-n) of “0 1 0 0” may recognize that the input signal 440 is the ragtime sampling. Further, the compressed output signals 1080(a-n” of “0 0 1 0” may recognize the input signal 440 is the hip-hop sampling. Thus, compressed output signals 1080(a-n) as generated by the output layer configuration 1000 may provide an easily recognizable identification of the initial input signal 440 that provides the temporal signal for the duration of time.

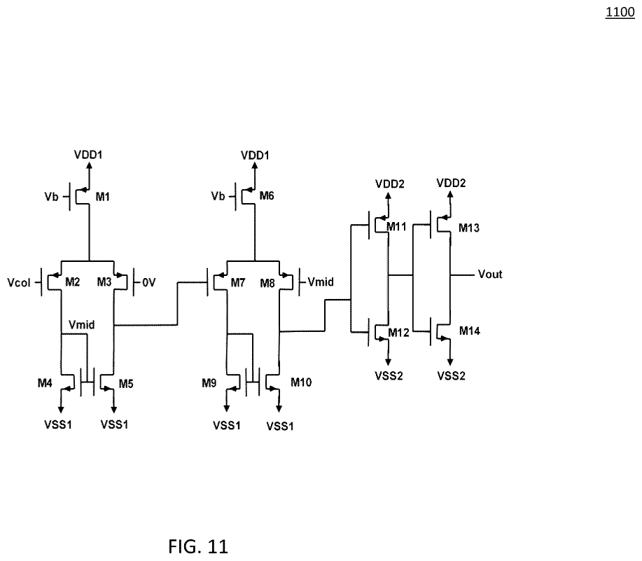

In an embodiment, comparators may be used at output neurons in the perceptron layer instead of more complex differential amplifiers. This provides an advantage in terms of circuit area, power, energy, and speed. The comparator circuit configuration 1100 may be used at the output to generate C₁ to C_{M} as displayed in FIG. 11. The binary neuron circuit may include two differential amplifiers developed using transistors M1 through M10 to check if V_{mid} has reached a threshold value. The resultant output may be driven by two inverters developed using transistors M11-M14.

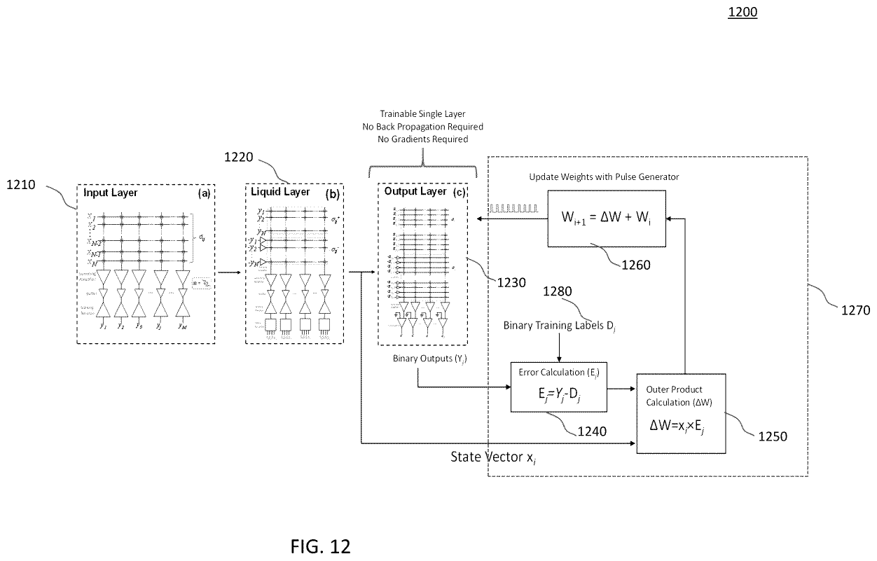

Referring to FIG. 12, in which like reference numerals are used to refer to like parts, a training liquid state configuration 1200 is shown. The training liquid state configuration 1200 shares many similar features with the analog neuromorphic processing device 100, the analog neuromorphic circuit 200, the neural network configuration 300, the analog neuromorphic liquid state configuration 400, the input layer configuration 500, the liquid layer configuration 800, and the output layer configuration 1000; therefore, only the differences between the training liquid state configuration 1200 and the analog neuromorphic processing device 100, the analog neuromorphic circuit 200, the neural network configuration 300, the analog neuromorphic liquid state configuration 400, the input layer configuration 500, the liquid layer configuration 800, and the output layer configuration 1000 are to be discussed in more detail.

As discussed above, the input signal 440 that provides the temporal signal for the duration of time is provided to the input layer 1210. The input layer 1210 includes input layer resistive memories provided in an input layer resistive memory crossbar configuration in which the weights of the input layer resistive memories are adjusted in a manner such that the input layer 1210 is encoded based on the input signal 440. The input layer 1210 then provides the encoded signals representing the input signal as classified to the liquid layer 1220. The liquid layer 1220 includes liquid layer resistive memories provided in a liquid layer resistive memory crossbar configuration in which the weights of the liquid layer resistive memories are adjusted in a manner such that the liquid layer counts the spikes generated by the liquid layer spiking neurons in which the counts of spikes identifies the data pattern of the input signal 440 for each classification. The liquid layer 1220 then provides the count of spikes to the output layer 1230. The output layer 1230 includes output layer resistive memories provided in an output layer resistive memory crossbar configuration in which the weights of the output layer resistive memories are adjusted in a manner such that the compressed output signals generated by the output layer 1230 represent the identification of the input signal 440 thereby identifying the temporal signal for the duration of time.

A training layer 1270 may train the output resistive memory crossbar configuration 1230 based on a difference in the identified temporal signal converted from the output voltages of the output resistive memory crossbar configuration as compared to the temporal signal for the duration of time. The output resistive memory crossbar configuration is trained to reduce the difference between the identified temporal signal and the temporal signal for the duration of time. As discussed above, the output voltages 1030(a-n) may be generated from the propagation of the counting voltages 1010(a-n) through the output layer resistive memory crossbar configuration 1070. The output voltages 1030(a-n) may then be compressed into the compressed output signals 1080(a-n). The compressed output signals 1080(a-n) may then represent the identification of the input signal 440 that provides the temporal signal for the duration of time.

However, in an embodiment, the output signal as generated by the output layer 1230 may provide an identified temporal signal in which the output signal provides an identification of a temporal signal but such identification may not be accurate. In such an embodiment, the output signal generated by the output layer may provide an identification of a temporal signal that does not match the initial input signal 440 that provides the temporal signal for the duration of time in which the initial input signal 440 that provides the temporal signal for the duration of time in which the output signal may provide that identified temporal signal that fails to accurately identify the temporal signal for the duration of time. As a result, the output signal generated by the output layer 1230 may then be compared to the initial input signal 440 that provides the temporal signal for the duration of time to determine if there is a difference between the output signal generated by the output layer 1230 and the initial input signal 440.

The output resistive memory crossbar configuration 1070 as included in the output layer 1230 may then be trained when there is a difference between the output signal generated by the output layer 1230 and the initial input signal 440 thereby indicating that the output signal incorrectly identifies the temporal signal for the duration of time. Rather than training the input layer resistive memory crossbar configuration 570 and the liquid layer resistive memory crossbar configuration 870, the output resistive memory crossbar configuration 1070 may be trained. The input layer resistive memories 520(a-n) included in the input layer resistive memory crossbar configuration 570 and the liquid layer resistive memories 820(a-n) included in the liquid layer resistive memory crossbar configuration 870 may remain static in which the once the weights of the input layer resistive memories 520(a-n) and the weights of the liquid layer resistive memories 820(a-n) are initially adjusted at the outset, such weights may remain throughout the numerous iterations of the training liquid state configuration 1200.

However, the weights of the output layer resistive memories 1020(a-n) may be trained through each iteration in which the output signal of the output layer 1230 as compared to the input signal 440. Such a difference between the output signal as generated by the output layer 1230 which is the identified temporal signal and the input signal 440 that provides the temporal signal for the duration of time may be determined and then the weights of the output layer resistive memories 1020(a-n) may be updated to account for the difference between the output signal and the input signal 440. Eventually, through iterations of comparing the output signal as generated by the output layer 1230 and the input signal 440, the weights of the output layer resistive memories 1020(a-n) may be trained such that the weights trigger the output signal as generated by the output layer 1230 that matches the input signal 440 thereby indicating that the identified temporal signal of the output layer 1230 correctly identifies the temporal signal for the duration of time as provide by the input signal 440. The training of the weights of the output layer resistive memories 1020(a-n) while maintaining the weights of the input layer resistive memories 520(a-n) and the liquid layer resistive memories 820(a-n) provides simplicity to the overall training of the training of training liquid state configuration 1200 to enable the correct identification of the temporal signal for the duration of time.

The output layer 1230 may compress each output voltage 1030(a-n) generated at each output of each column included in the output resistive memory crossbar configuration 1070 from the propagation of counting voltages 1010(a-n) through the resistive memory crossbar configuration 1070 to a compressed output signal 1080(a-n). The compressed output signal 1080(a-n) is a binary voltage value that represents each corresponding output voltage 1030(a-n) and is included in the identified temporal signal provided to the training layer 1270. As discussed above, the compressed output signals 1080(a-n) provide a binary voltage value of a “0” or a “1” that represents the corresponding output voltage 1030(a-n) that is thereby generated as the identified temporal signal that may be compared to the temporal signal for the duration of time as provided by the input signal 440. The compressed output signals 1080(a-n) of a “0” or a “1” may then be compared to the correct identification of the input signal 440 that provides the temporal signal for the duration of time. For example, the compressed output signals 1080(a-n) may generate the identified temporal signal of “1 0 0 0” which identifies the classical sample. However, the temporal signal is actually “0 1 0 0” which identifies the ragtime sample as the temporal signal for the duration of time as provided by the input signal 440 is ragtime sample and not the classical sample.

The training layer 1230 may determine each actual binary voltage value that corresponds to the binary voltage value included in each corresponding compressed output signal 1080(a-n) generated from each compressed output voltage of each output of each column included in the output resistive memory crossbar configuration 1070 and included in the identified temporal signal. Each actual binary voltage value corresponds to a correct identification of the temporal signal for the duration of time. The training layer 1230 may determine the actual binary voltage value that correctly corresponds to the temporal signal for the duration of time as provide by the input signal. For example, the training layer 1230 may identify that the actual binary voltage value that correctly identifies the ragtime sample of the temporal signal for the duration of time to be “0 1 0 0”.

In an embodiment, the actual binary voltage values that correctly identify the temporal signal for the duration of time as provided by the input signal 440 may be numerous such that the actual binary voltage values may be provided in a vector matrix. Binary training labels 1280 may then be associated with each actual binary voltage value as provided in the vector matrix. In doing so, the actual binary voltage values that correctly identify the temporal signal may be compared to the binary voltage values provided by the compressed output signals 1080(a-n) of the identified temporal signal to determine the difference between the identified temporal signal of the compressed output signals 1080(a-n) and the actual temporal signal provided by the input signal 440.

The training layer 1270 may compare each binary voltage value that represents each corresponding output voltage and is included in the identified temporal signal provided to the training layer 1270 to each corresponding actual binary voltage value that corresponds to the correct identification of the temporal signal for the duration of time. The training layer 1270 may determine a deviation between each binary voltage value and each corresponding actual binary voltage value. The deviation between each binary voltage value and each corresponding actual binary voltage value is indicative of an error between the identified temporal signal and the correct identification of the temporal signal for the duration of time. The training layer 1270 may update each weight associated with each output layer resistive memory 1020(a-n) included in the output resistive memory crossbar configuration 1070 based on the deviation between each binary voltage value and each corresponding actual binary voltage value to train the output resistive memory crossbar configuration 1070.

In an embodiment, the binary voltage provided by each compressed output signal 1080(a-n) may also be numerous and may be equivalent to the actual binary voltages that correctly identify the temporal signal for the duration of time. In doing so, the binary voltages provided by each compressed output signal 1080(a-n) may also be mapped to a vector matrix in which the vector matrix of the binary voltages provided by each compressed output signal 1080(a-n) may represent the identified temporal signal which is the attempt of the output layer 1230 to identify the temporal signal. Each binary voltage provided by each compressed output signal 1080(a-n) as provided in the vector matrix may correspond to each actual binary voltage value as provided in the vector matrix that correctly identifies the temporal signal for the duration of time. As a result, the binary training labels 1280 provided in the vector matrix that correctly identifies the temporal signal for the duration of time may be compared to the binary voltage provided by each compressed output signal 1080(a-n) as provided in the vector matrix that provides the identified temporal signal to determine the difference between the identified temporal signal by the compressed output signals 1080(a-n) and the actual temporal signal.

The error calculation 1240 may compare the vector matrix that includes the binary training labels 1280 that correctly identifies the temporal signal with the vector matrix that includes the binary voltages provided by the compressed output signals 1080(a-n) that provide the attempted identified temporal signal. Each corresponding value in each vector matrix may be compared to determine the deviation. For example, a first binary training label value in a first position of the vector matrix of “1” is compared to a first compressed output signal 1080a in a first positon of the vector matrix of “−1”. Such a difference is “0” thereby indicating that the first compressed output signal 1080a in the first position of the vector matrix is correct as compared to the first binary training label value in the first position of the vector matrix. A second binary training label value in a second position of the vector matrix of “1” is compared to a second compressed output signal 1080b in a second positon of the vector matrix of “1”. Such a difference is “2” thereby indicating that the second compressed signal 1080b in the second position of the vector matrix is incorrect as compared to the second binary training label value in the second position of the vector matrix. A third binary training label value in a third positon of the vector matrix of “−1” is compared to a third compressed output signal 1080c in a third position of the vector matrix of “−1”. Such a difference is “−2” thereby indicating that the third compressed signal 1080c in the third positon of vector matrix is incorrect as compared to the third binary training label value in the third position of the vector matrix.

In doing so, an error matrix may be generated by the error calculation 1240 in which the difference between each binary training label value is compared to each binary voltage of each corresponding compressed output signal 1080(a-n). A difference in “0” as provided in the error matrix may map to a corresponding output layer resistive memory 1020(a-n) that indicates the weight of such corresponding output layer resistive memory 1020(a-n) is correct and no further training of such weight is needed. However, a difference that provides a value other than “0” as provided in the error matrix may map to a corresponding output layer resistive memory 1020(a-n) that indicates the weight of such corresponding output layer resistive memory 1020(a-n) is incorrect and the training of such weight is needed. For example, a difference in “2” and/or “−2” as provided by the error matrix may indicate that the weight of a corresponding output layer resistive memory 1020(a-n) is incorrect and requires training.

The training layer 1270 may update each weight associated with each output layer resistive memory 1020(a-n) included in the output resistive memory crossbar configuration 1070 thereby reducing the error between the identified temporal signal and the correct identification of the temporal signal for the duration of time for each iteration of input voltages 510(a-n) applied to the input layer 120 thereby propagating through the input layer 1210 and the liquid layer 1220. An outer product calculation 1250 may be conducted on the error vector matrix and the state vector matrix which is the initial voltage values provided to the output layer resistive memory crossbar configuration 1070 to generate an updated weight matrix 1260. The updated weight matrix 1260 may include the values in which the weight of each corresponding output layer resistive memory 1020(a-n) is to be updated in order to train the corresponding output layer resistive memory to generate a difference in “0” as compared to non-zero such as “−2” and/or “2”. A positive value in the weight matrix 1260 indicates that the weight for the corresponding output layer resistive memory 1020(a-n) is to be adjusted in a positive direction. A negative value in the weight matrix 1260 indicates that the weight for the corresponding output layer resistive memory 1020(a-n) is to be adjusted in the negative direction. A “0” value in the weight matrix 1260 indicates that the weight for the corresponding output layer resistive memory 1020(a-n) is correct and does not need to be adjusted.

The weight matrix 1260 may then be applied to the output layer resistive memories 1020(a-n) as included in the output layer resistive memory crossbar configuration 1070 in which the values in the weight matrix 1260 provide the adjustments in weight or lack thereof to each corresponding output layer resistive memory 1020(a-n). The training of the weights for the output layer resistive memories 1020(a-n) may then continue in which each iteration for which the input signal 440 providing the temporal signal for the duration of time is applied to the input layer 1210 continues to update the weights of each output layer resistive layer resistive memory 1020(a-n) to reduce the error between the identified temporal signal as provided by compressed output signals 1080(a-n) and the actual temporal signal for the duration of time. The training of the weights for the output layer resistive memories 1020(a-n) may continue until the error between the identified temporal signal as provided by the compressed output signals 1080(a-n) and the actual temporal signal for the duration of time as provided by the input signal 440 is sufficiently reduced such that the identified temporal signal as provided by the compressed output signals 1080(a-n) correctly identifies the temporal signal for the duration of time as provided by the input signal 440.

The training layer configuration 1200 may execute training algorithms such as those disclosed with regard to supervised learning as discussed in detail in U.S. Nonprovisional application Ser. No. 17/364,019 which is incorporated by reference in its entirety. The training layer configuration 1200 may also execute training algorithms such as those disclosed with regard to unsupervised learning as discussed in detail in U.S. Nonprovisional application Ser. No. 17/384,306 which is incorporated by reference in its entirety. The training layer configuration 1200 may also execute training algorithms such as those disclosed with regard to back propagation as discussed in detail in U.S. Nonprovisional application Ser. No. 17/141,981 which is incorporated by reference in its entirety. The training layer configuration 1200 may also incorporate any other training algorithms and/or architecture that may be implemented by an analog neuromorphic circuit configuration that will be apparent to those skilled in the art relevant art(s) without departing from the spirit and scope of the disclosure.

It is to be appreciated that the Detailed Description section, and not the Abstract section, is intended to be used to interpret the claims. The Abstract section can set forth one or more, but not all exemplary embodiments, of the present disclosure, and thus, is not intended to limit the present disclosure and the appended claims in any way.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in art. The invention in its broader aspects is therefore not limited to the specific details, representative apparatus and method and illustrative examples shown and described. Accordingly, departures may be made from such details without departing from the scope of the general inventive concept.

What is claimed is:

1. An analog neuromorphic circuit that implements a plurality of resistive memories, comprising:
an input layer configured to encode a plurality of input layer spiking neurons based on a plurality of encoding signals generated from a plurality of input voltages applied to the input layer via an input layer resistive memory crossbar configuration thereby encoding each input layer spiking neuron to spike when the corresponding encoding signal applied to each input layer spiking neuron is increased above an input layer spiking voltage threshold, wherein the encoding signal applied to each input layer spiking neuron that is increased above the input spiking threshold is indicative of a temporal signal for a duration of time;
a liquid layer configured to count each spike generated by a plurality of liquid layer spiking neurons for the duration of time based on a plurality of liquid layer signals generated from a plurality of input layer spiking neuron voltages generated from each input layer spiking neuron based on the plurality of input layer spiking neuron voltages applied to the liquid layer via a liquid layer resistive memory crossbar configuration thereby triggering each liquid layer spiking neuron to spike when the corresponding liquid layer signal is increased above a liquid layer spiking voltage threshold, wherein each spike generated by the plurality of liquid layer spiking neurons for the duration of time that is generated is indicative of the temporal signal for the duration of time; and
an output layer configured to identify the temporal signal for the duration of time based on a plurality of output voltages generated from a plurality of counting voltages generated from the count of each spike generated by the plurality of liquid layer spiking neurons for the duration of time applied to the output layer via an output resistive memory crossbar configuration, wherein the plurality of output voltages generated from the output resistive memory crossbar configuration is indicative of the temporal signal for the duration of time.

2. The analog neuromorphic circuit of claim 2, wherein the input layer is further configured to:
propagate the plurality of input voltages applied to the input layer resistive memory crossbar configuration through a plurality of input resistive memories positioned in the input layer resistive memory crossbar configuration thereby generating the plurality of encoding signals, wherein each weight of each input layer resistive memory is adjusted to generate the plurality of encoding signals that is indicative of the temporal pattern for the duration of time; and
classify each encoding signal based on the weights of each input layer resistive memory as applied to each corresponding input layer spiking neuron as the plurality of input voltages propagate through the plurality of input resistive memories thereby triggering each corresponding input layer spiking neuron to spike when the corresponding encoding signal applied to each corresponding input layer spiking neuron is increased above the input layer spiking threshold, wherein a combination of input layer spiking neurons that spike generates a plurality of input layer spiking neuron voltages that is indicative of the temporal signal for the duration of time.

3. The analog neuromorphic circuit of claim 1, wherein the liquid layer is further configured to:
propagate the plurality of input layer spiking neuron voltages generated from the plurality of input layer spiking neurons and propagate the plurality of input layer spiking neuron voltages as a corresponding negative inverted value of each input layer spiking neuron voltage as applied to the liquid layer resistive memory crossbar configuration through a plurality of liquid layer resistive memories positioned in the liquid layer resistive memory crossbar configuration thereby generating the plurality of liquid layer signals, wherein each weight of the liquid layer resistive memory crossbar configuration is adjusted to generate the plurality of liquid layer signals that is indicative of the temporal pattern for the duration of time; and
classify each liquid layer signal based on the weights of each liquid layer resistive memory as applied to each corresponding liquid layer spiking neuron as the plurality of input layer spiking neuron voltages and each corresponding negative inverted value of each input layer spiking neuron propagate through the plurality of liquid layer resistive memories thereby triggering each corresponding liquid layer spiking neuron to spike when the corresponding liquid layer signal applied to each corresponding liquid layer spiking neuron is increased above the liquid layer spiking voltage threshold, wherein a count of liquid layer spiking neurons that spike for the duration of time generates the plurality of counting voltages that is indicative of the temporal signal for the duration of time.

4. The analog neuromorphic circuit of claim 3, wherein the liquid layer is further configured to:
generate the count of liquid layer spiking neurons that spike for the duration of time when a plurality of spike counters associated with each corresponding liquid layer spiking neuron detects a liquid layer spiking neuron voltage from each corresponding liquid layer spiking neuron that spikes for the duration of time thereby triggering each spike counter to generate each corresponding counting voltage that is indicative of each time each liquid layer spiking neuron spiked, wherein the counting voltages generated by each spike counter is indicative of the temporal signal for the duration of time.

5. The analog neuromorphic circuit of claim 4, wherein the liquid layer is further configured to:
output the counting voltages generated by each corresponding spike counter as a corresponding binary signal generated by each corresponding spike counter that is indicative of each time each liquid layer spiking neuron that is associated with each corresponding spike counter spiked, wherein each counting voltage associated with each spike counter is a binary bit that is converted into the corresponding binary signal generated by each spike counter thereby providing the count of spikes by each liquid layer spiking neuron during the duration of time via the binary signals generated by each corresponding spike counter.

6. The analog neuromorphic circuit of claim 5, wherein the output layer is further configured to:
propagate the plurality of counting voltages generated from the spike counters that provides the count of each time each liquid layer spiking neuron spiked during the duration of time and propagate the plurality of counting voltages as a corresponding negative inverted value of each counting voltage as applied to the output resistive memory crossbar configuration through a plurality of output layer resistive memories positioned in the output resistive memory crossbar configuration thereby generating the plurality of output voltages that is indicative of the temporal pattern for the duration of time, wherein each output voltage is generated at each output of each column included in the output resistive memory crossbar configuration.

7. The analog neuromorphic circuit of claim 6, wherein the output layer is further configured to:
compress each output voltage generated at each output of each column included in the output resistive memory crossbar configuration from the propagation of the counting voltages through the resistive memory crossbar configuration to a compressed output signal, wherein each compressed output signal is a binary voltage value that represents the output voltage; and
identify the temporal signal for the duration of time based on a combination of each compressed output signal, wherein the combination of compressed output signals is indicative of the temporal signal for the duration of time.

8. A method for implementing an analog neuromorphic circuit to identify a temporal signal for a duration of time, comprising:
encoding a plurality of input layer spiking neurons based on a plurality of encoding signals generated from a plurality of input voltages applied to the input layer via an input layer resistive memory crossbar configuration thereby encoding each input layer spiking neuron to spike when the corresponding encoding signal applied to each input layer spiking neuron is increased above an input layer spiking voltage threshold, wherein the encoding signal applied to each input layer spiking neuron that is increased above the input spiking threshold is indicative of a temporal signal for a duration of time;
counting each spike generated by a plurality of liquid layer spiking neurons for the duration of time based on a plurality of liquid layer signals generated from a plurality of input layer spiking neuron voltages generated from each input layer spiking neuron based on the plurality of input layer spiking neuron voltages applied to the liquid layer via a liquid layer resistive memory crossbar configuration thereby triggering each liquid layer spiking neuron to spike when the corresponding liquid layer signal is increased above a liquid layer spiking voltage threshold, wherein each spike generated by the plurality of liquid layer spiking neurons for the duration of time that is generated is indicative of the temporal signal for the duration of time; and
identifying the temporal signal for the duration of time based on a plurality of output voltages generated from a plurality of counting voltages generated from the count of each spike generated by the plurality of liquid layer spiking neurons for the duration of time applied to the output layer via an output resistive memory crossbar configuration, wherein the plurality of output voltages generated from the output resistive memory crossbar configuration is indicative of the temporal signal for the duration of time.

9. The method of claim 8, wherein the encoding comprises:
propagating the plurality of input voltages applied to the input layer resistive memory crossbar configuration through a plurality of input resistive memories positioned in the input layer resistive memory crossbar configuration thereby generating the plurality of encoding signals, wherein each weight of each input layer resistive memory is adjusted to generate the plurality of encoding signals that is indicative of the temporal pattern for the duration of time; and
classifying each encoding signal based on the weights of each input layer resistive memory as applied to each corresponding input layer spiking neuron as the plurality of input voltages propagate through the plurality of input resistive memories thereby triggering each corresponding input layer spiking neuron to spike when the corresponding encoding signal applied to each corresponding input layer spiking neuron is increased above the input layer spiking threshold, wherein a combination of input layer spiking neurons that generates a plurality of input layer spiking neuron voltages that is indicative of the temporal signal for the duration of time.

10. The method of claim 8, wherein the counting comprises:
propagating the plurality of input layer spiking neuron voltages generated from the plurality of input layer spiking neurons and propagate the plurality of input layer spiking neuron voltages as a corresponding negative inverted value of each input layer spiking neuron voltages as applied to the liquid layer resistive memory crossbar configuration through a plurality of liquid layer resistive memories positioned in the liquid layer resistive memory crossbar configuration thereby generating the plurality of liquid layer signals, wherein each weight of the liquid layer resistive memory crossbar configuration is adjusted to generate the plurality of liquid layer signals that is indicative of the temporal pattern for the duration of time; and
classifying each liquid layer signal based on the weights of each liquid layer resistive memory as applied to each corresponding liquid layer spiking neuron as the plurality of input layer spiking neuron voltages and each corresponding negative inverted value of each input layer spiking neuron propagate through the plurality of liquid layer resistive memories thereby triggering each corresponding liquid layer spiking neuron to spike when the corresponding liquid layer signal applied to each corresponding liquid layer spiking neuron is increased above the liquid layer spiking voltage threshold, wherein a count of liquid layer spiking neurons that spike for the duration of time generates the plurality of counting voltages that is indicative of the temporal signal for the duration of time.

11. The method of claim 10, wherein the counting further comprises:
generating the count of liquid layer spiking neurons that spike for the duration of time when a plurality of spike counters associated with each corresponding liquid layer spiking neuron detects a liquid layer spiking neuron voltage from each corresponding liquid layer spiking neuron that spikes for the duration of time thereby triggering each spike counter to generate each corresponding counting voltage that is indicative of each liquid layer spiking neuron that spiked, wherein the counting voltages generated by each spike counter is indicative of the temporal signal for the duration of time.

12. The method of claim 11, further comprising:
outputting the counting voltages generated by each corresponding spike counter as a corresponding binary signal generated by each corresponding spike counter that is indicative of each time each liquid layer spiking neuron that is associated with each corresponding spike counter that spiked, wherein each counting voltage associated with each spike counter is a binary bit that is converted into the corresponding binary signal generated by each spike counter thereby providing the count of spikes by each liquid layer spiking neuron during the duration of them via the binary signals generated by each corresponding spike counter.

13. The method of claim 12, further comprising:
propagating the plurality of counting voltages generated from the spike counters that provides the count of each time each liquid layer spiking neuron spiked during the duration of time and propagate the plurality of counting voltages as a corresponding negative inverted value of each counting voltage as applied to the output resistive memory crossbar configuration through a plurality of output layer resistive memories positioned in the output resistive memory crossbar configuration thereby generating the plurality of output voltages that is indicative of the temporal pattern for the duration of time, wherein each output voltage is generated at each output of each column included in the output resistive memory crossbar configuration.

14. The method of claim 13, further comprising:
compressing each output voltage generated at each output of each column included in the output resistive memory crossbar configuration from the propagation of the counting voltages through the resistive memory crossbar configuration to a compressed output signal, wherein each compressed output signal is a binary voltage value that represents the output voltages; and
identifying the temporal signal for the duration of time based on a combination of each compressed output signal, wherein the combination of compressed output signals is indicative of the temporal signal for the duration of time.

15. An analog neuromorphic circuit that implements a plurality of resistive memories, comprising:
an input layer configured to encode a plurality of input layer spiking neurons based on a plurality of encoding signals generated from a plurality of input voltages applied to the input layer via an input layer resistive memory crossbar configuration thereby encoding each input layer spiking neuron to spike when the corresponding encoding signal is applied to each input layer spiking neuron is increased above an input layer spiking voltage threshold, wherein the encoding signal is applied to each input layer spiking neuron that is increased above the input spiking neuron threshold is indicative of a temporal signal for a duration of time;
a liquid layer configured to count each spike generated by a plurality of liquid layer spiking neurons for the duration of time based on a plurality of liquid layer signals generated from a plurality of input layer spiking neuron voltages generated from each input layer spiking neuron based on the plurality of input layer spiking neuron voltages applied to the liquid layer via a liquid layer resistive memory crossbar configuration thereby triggering each liquid layer spiking neuron to spike when the corresponding liquid layer signal is increased above a liquid layer spiking voltage threshold, wherein each spike generated by the plurality of liquid layer spiking neurons for the duration of time that is generated is indicative of the temporal signal for the duration of time;
an output layer configured to generate an identified temporal signal converted from a plurality of output voltages generated from a plurality of counting voltages generated from the count of each spike generated by the plurality of liquid layer spiking neurons for the duration of time applied to the output layer via an output resistive memory crossbar configuration, wherein the identified temporal signal converted from the plurality of output voltages generated from the output resistive memory crossbar configuration is an attempt to identify the temporal signal for the duration of time; and
a training layer configured to train the output resistive memory crossbar configuration based on a difference in the identified temporal signal converted from the output voltages of the output resistive memory crossbar configuration as compared to the temporal signal for the duration of time, wherein the output resistive memory crossbar configuration is trained to reduce the difference between the identified temporal signal and the temporal signal for the duration of time.

16. The analog neuromorphic circuit of claim 15, wherein the output layer is further configured to:
compress each output voltage generated at each output of each column included in the output resistive memory crossbar configuration from the propagation of the counting voltages through the resistive memory crossbar configuration to a compressed output signal, wherein each compressed output signal is a binary voltage value that represents each corresponding output voltage and is included in the identified temporal signal provided to the training layer.

17. The analog neuromorphic circuit of claim 16, wherein the training layer is further configured to:
determine each actual binary voltage value that corresponds to each binary voltage value included in each corresponding compressed output signal generated from each compressed output voltage at each output of each column included in the output resistive memory crossbar configuration and included in the identified temporal signal, wherein each actual binary voltage value corresponds to a correct identification of the temporal signal for the duration of time.

18. The analog neuromorphic circuit of claim 17, wherein the training layer is further configured to:
compare each binary voltage value that represents each corresponding output voltage and is included in the identified temporal signal provided to the training layer to each corresponding actual binary voltage value that corresponds to the correct identification of the temporal signal for the duration of time;
determine a deviation between each binary voltage value and each corresponding actual binary voltage value, wherein the deviation between each binary voltage value and each corresponding actual binary voltage value is indicative of an error between the identified temporal signal and the correct identification of the temporal signal for the duration of time; and
update each weight associated with each output layer resistive memory included in the output resistive memory crossbar configuration based on the deviation between each binary voltage value and each corresponding actual binary voltage value to train the output resistive memory crossbar configuration.

19. The analog neuromorphic circuit of claim 18, wherein the training layer is further configured to:
update each weight associated with each output layer resistive memory included in the output resistive memory crossbar configuration thereby reducing the error between the identified temporal signal and the correct identification of the temporal signal for the duration of time for each iteration of input voltages applied to the input layer thereby propagating through the input layer and liquid layer.

20. The analog neuromorphic circuit of claim 19, wherein each resistive memory is a memristor.
